(19) United States
(12) Patent Application Publication
(10) Pub. No.: US 2017/0205013 A1
(43) Pub. Date: Jul. 20, 2017

(54) FITTINGS AND CONNECTORS FOR IRRIGATION SYSTEMS

(71) Applicants: Duane K. Smith, Weldon Springs, MO (US); Thomas A. King, Chesterfield, MO (US); Scott L. Blankley, Wildwood, MO (US)

(72) Inventors: Duane K. Smith, Weldon Springs, MO (US); Thomas A. King, Chesterfield, MO (US); Scott L. Blankley, Wildwood, MO (US)

(21) Appl. No.: 15/480,261

(22) Filed: Apr. 5, 2017

Related U.S. Application Data
(63) Continuation-in-part of application No. 14/947,822, filed on Nov. 20, 2015.
(60) Provisional application No. 62/083,051, filed on Nov. 21, 2014.
(60) Provisional application No. 62/319,091, filed on Apr. 6, 2016.
(60) Provisional application No. 62/452,624, filed on Jan. 31, 2017.
(60) Provisional application No. 62/472,063, filed on Mar. 16, 2017.

(51) Int. Cl. F16L 41/06; A01G 25/02; B05B 15/06

(52) U.S. Cl. CPC F16L 41/065; B05B 15/065; A01G 25/02

(57) ABSTRACT

A fitting for use in making a fluid connection with a pipe includes a saddle adapted to couple the fitting to the pipe. The saddle includes a body and first and second arms configured to extend at least partly around the pipe when coupling the fitting to the pipe. The fitting also includes a tap member adapted to insert at least partly into the pipe when the saddle couples the fitting to the pipe, to thereby establish the fluid connection between the fitting and the pipe. The tap member includes at least one support arm configured to moveably couple the tap member to the saddle such that the first and second arms of the saddle can be extended at least partly around the pipe prior to inserting the tap member at least partly into the pipe.

### CROSS-REFERENCE TO RELATED APPLICATIONS

This application claims the benefit of, and priority to, U.S. Provisional Application No. 62/319,091, filed on Apr. 6, 2016, U.S. Provisional Application No. 62/452,624, filed on Jan. 31, 2017, and U.S. Provisional Application No. 62/472,063, filed on Mar. 16, 2017. This application is also a continuation-in-part of U.S. patent application Ser. No. 14/947,822, filed on Nov. 20, 2015, which claims the benefit of, and priority to, U.S. Provisional Application No. 62/083,051, filed on Nov. 21, 2014. The entire disclosures of the above applications are incorporated herein by reference.

### FIELD

The present disclosure generally relates to fittings and connectors and, more particularly, to quick-connect fittings and connectors for use in irrigation systems.

### BACKGROUND

This section provides background information related to the present disclosure which is not necessarily prior art.

Underground irrigation systems are often used to direct water to vegetation to help facilitate growth of the vegetation. Typically, the underground irrigation systems include main water lines and lateral lines extending therefrom. The lateral lines are connected to the main lines through various pipe fittings, and interconnect the main lines with one or more irrigation sprinkler heads for distributing the water to the vegetation.

### SUMMARY

This section provides a general summary of the disclosure, and is not a comprehensive disclosure of its full scope or all of its features.

Exemplary embodiments of the present disclosure generally relate to assemblies comprising fittings and connectors for use in making fluid connections with pipes, for example, in irrigation systems, etc. Exemplary embodiments of the fittings and connectors can be coupled together via quick-connect couplings, to create the fluid connections with the pipes, for example, without threading the fittings and connectors, or portions thereof, together.

In one exemplary embodiment, a fitting for use in making a fluid connection with a pipe includes a saddle adapted to couple the fitting to the pipe. The saddle includes a body and first and second arms configured to engage the pipe when coupling the fitting to the pipe. The fitting also includes a tap member adapted to insert at least partly into the pipe when the saddle couples the fitting to the pipe, to thereby establish the fluid connection between the fitting and the pipe. The tap member includes at least one support arm configured to moveably couple the tap member to the saddle such that the first and second arms of the saddle can be extended at least partly around the pipe prior to inserting the tap member at least partly into the pipe.

In another exemplary embodiment, a quick-connect coupling for use in making a fluid connection between a fitting and a connector in an irrigation system generally includes at least one quick-connect opening defined by the fitting and/or the connector of the irrigation system, and at least one quick-connect protrusion defined by the fitting and/or the connector of the irrigation system. The at least one quick-connect protrusion is configured to fit within the at least one quick-connect opening to thereby couple the fitting and the connector and establish the fluid connection between the fitting and the connector.

Exemplary embodiments of the present disclosure also generally relate to snap clips for coupling connectors and fittings in irrigation systems. In one exemplary embodiment, such a snap clip generally includes a first wall portion having an outer threaded surface and an inner non-threaded surface, a second wall portion opposite the first wall portion where the second wall portion has an outer threaded surface and an inner non-threaded surface, and a bridge member coupling the first wall portion to the second wall portion. The bridge member separates the outer threaded surface of the first wall portion form the outer threaded surface of the second wall portion.

In another exemplary embodiment, a method of using a snap clip to couple a connector to a fitting for use in making a fluid connection with a pipe is provided. In this embodiment, the snap clip includes at least one wall portion having an external threaded surface and an internal non-threaded surface. The method generally includes inserting the snap clip into a threaded opening of the fitting to create a threaded coupling of the snap clip to the opening of the fitting, and inserting a protrusion of the connector into the snap clip to create a friction fit between the protrusion of the connector and the internal non-threaded surface of the snap clip.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of an exemplary embodiment of a fitting of the present disclosure, shown installed in an irrigation system;

FIG. 2 is an enlarged perspective view of the fitting of FIG. 1, shown installed to a main line in the irrigation system;

FIG. 3 is a perspective view of the fitting of FIG. 1;

FIG. 4 is another perspective view of the fitting of FIG. 1;

FIG. 5 is a front view of the fitting of FIG. 1;

FIG. 6 is a left side view of the fitting of FIG. 1;

FIG. 7 is a right side view of the fitting of FIG. 1;

FIG. 8 is a top view of the fitting of FIG. 1;

FIG. 9 is a bottom view of the fitting of FIG. 1;

FIG. 10 is an enlarged side view of a tip portion of a tap of the fitting of FIG. 1;

FIG. 11 is a front view of another exemplary embodiment of a fitting of the present disclosure;

FIG. 12 is a bottom view of the fitting of FIG. 11;

FIG. 13 is a longitudinal section view of the fitting of FIG. 11;

FIG. 14 is an enlarged side view of a tip portion of a tap of the fitting of FIG. 11;

FIG. 15 is a perspective view of another exemplary embodiment of a fitting of the present disclosure;

FIG. 16 is a perspective view of the fitting of FIG. 15, and with a connector shown generally above the fitting suitable for coupling to the fitting;

FIG. 17 is another perspective view of the fitting and the connector of FIG. 16;

FIG. 18 is a perspective view of an exemplary embodiment of a spacer suitable for use in coupling a fitting of the present disclosure to a pipe;

FIG. 19 is a front view of another exemplary embodiment of a fitting of the present disclosure;

FIG. 20 is an elevation view of an exemplary embodiment of a fitting and a connector of the present disclosure;

FIG. 21 is an elevation view of the fitting and the connector of FIG. 20, with the fitting and the connector shown coupled together;

FIG. 22 is a fragmentary view of the fitting and the connector of FIG. 20 showing a quick-connect coupling between the fitting and the connector;

FIG. 23 is an elevation view of another exemplary embodiment of a fitting and a connector of the present disclosure;

FIG. 24 is a fragmentary view of the fitting and the connector of FIG. 23 showing a quick-connect coupling between the fitting and the connector;

FIG. 25 is an elevation view of an exemplary embodiment of a sprinkler head fitting and a connector of the present disclosure;

FIG. 26 is an elevation view of the sprinkler head fitting and the connector of FIG. 25 shown coupled together;

FIG. 27 is a section view of the sprinkler head fitting and the connector of FIG. 26 taken in a plane including line 27-27 in FIG. 26;

FIG. 28 is an elevation view of another exemplary embodiment of a fitting and a connector of the present disclosure;

FIG. 29 is an elevation view of the fitting and the connector of FIG. 28, with the fitting and the connector shown coupled together;

FIG. 30 is a section view of the fitting and the connector of FIG. 29 taken in a plane including line 30-30 in FIG. 29;

FIG. 31 is an elevation view of still another exemplary embodiment of a fitting and a connector of the present disclosure;

FIG. 32 is a fragmentary view of the fitting and the connector of FIG. 31 showing a quick-connect coupling between the fitting and the connector;

FIG. 33 is an elevation view of another exemplary embodiment of a fitting and a connector of the present disclosure;

FIG. 34 is an elevation view of the fitting and the connector of FIG. 33, with the fitting and the connector shown coupled together;

FIG. 35 is a section view of the fitting and the connector of FIG. 34 taken in a plane including line 35-35 in FIG. 34;

FIG. 36 is an elevation view of another exemplary embodiment of a fitting and a connector of the present disclosure;

FIG. 37 is a section view of the fitting and connector of FIG. 36 taken in a plane including line 37-37 in FIG. 36;

FIG. 38 is an isometric view of a clip associated with the fitting of FIG. 36;

FIG. 39 is a top view of the clip of FIG. 38;

FIG. 40 is an elevation view of the clip of FIG. 38;

FIG. 41 is an exploded elevation view of an exemplary embodiment of a sprinkler head fitting and a connector of the present disclosure;

FIG. 42 is an exploded elevation view of another exemplary embodiment of a fitting and a connector of the present disclosure;

FIG. 43 is an elevation view of another exemplary embodiment of a fitting of the present disclosure;

FIG. 44 is an elevation view of the fitting of FIG. 43 with a tap member of the fitting coupled to a saddle of the fitting;

FIG. 45 is an elevation view of the fitting of FIG. 43 shown installed to a pipe;

FIG. 46 is a perspective view of the fitting of FIG. 43 shown installed to the pipe;

FIG. 47 is an elevation view of another exemplary embodiment of a fitting of the present disclosure, which is similar to the fitting of FIG. 43 but does not include tabs located along the tap;

FIG. 48 is an elevation view of the fitting of FIG. 47 shown installed to a pipe;

FIG. 49 is an isometric view of another exemplary embodiment of a fitting of the present disclosure having a strap on one arm of the saddle;

FIG. 50 is an isometric view of another exemplary embodiment of a fitting of the present disclosure having a strap defining an opening on one arm of the saddle; and

FIG. 51 is an isometric view of another exemplary embodiment of a fitting of the present disclosure having a jaw portion on one arm of the saddle that engages a catch on another arm of the saddle.

FIG. 52 is an elevation view of another exemplary embodiment of a fitting of the present disclosure.

FIG. 53 is an isometric view of the fitting of FIG. 52.

Corresponding reference names indicate corresponding parts throughout the several views of the drawings.

### DETAILED DESCRIPTION

The description and specific examples provided herein are intended for purposes of illustration only and are not intended to limit the scope of the present disclosure.

Exemplary embodiments of the present disclosure generally relate to fittings, for example, for use in irrigation systems used to direct water to vegetation. The fittings of the present disclosure can be used in the irrigation systems to interconnect main lines (or other lines) of the systems with other components of the systems, for example, sprinkler heads for distributing the water to the vegetation (e.g., from main lines of the irrigation systems, etc.), etc. In various embodiments, the fittings are single structures or pieces that, uniquely, can be press-fit (e.g., manually by users, etc.) onto the lines of the irrigation systems to establish fluid connection, without threading or rotating the fittings (or any portions thereof) in order to install them to the lines.

Exemplary embodiments of the present disclosure also generally relate to assemblies comprising fittings and connectors for use in making fluid connections with pipes, for example, in irrigation systems, etc. In the assemblies, the fittings and the connectors are configured to be coupled together via quick-connect couplings, to create the fluid connections with the pipes.

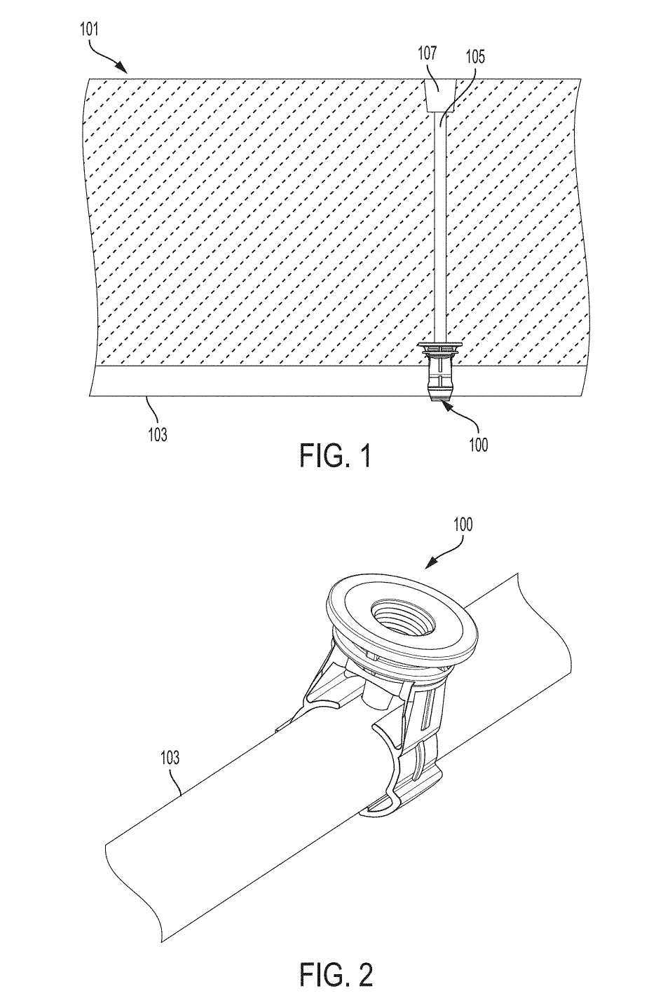

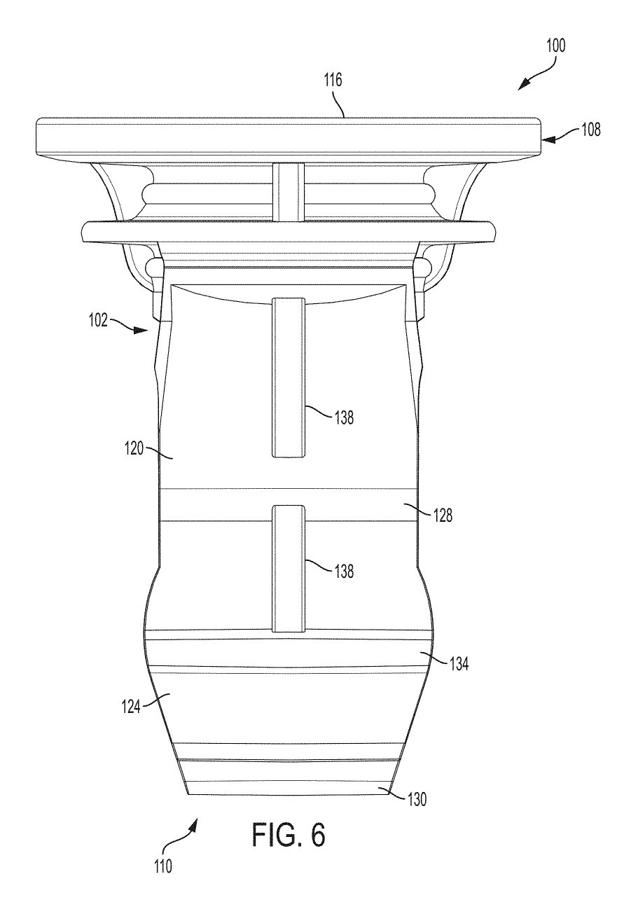

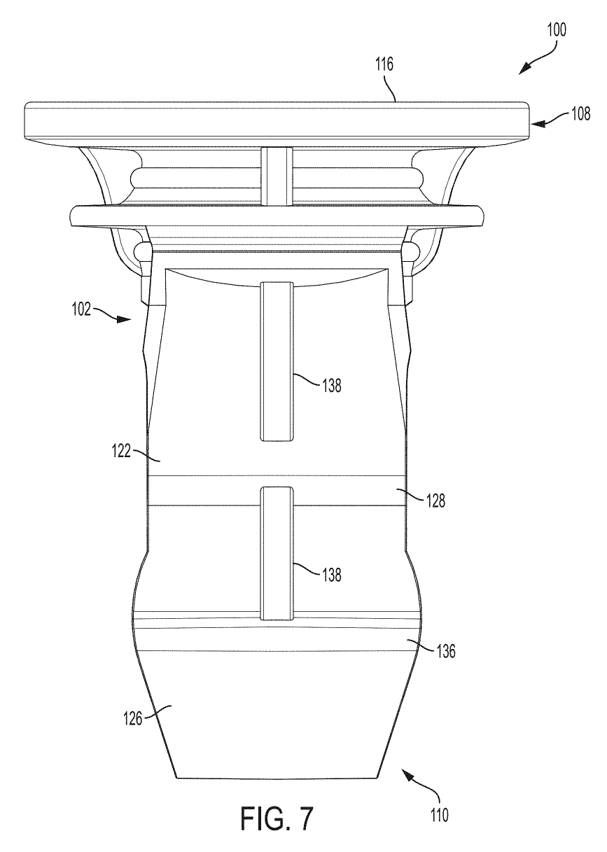

With reference now to the drawings, FIGS. 1-10 illustrate an exemplary embodiment of a fitting 100 including one or more aspects of the present disclosure.

As shown in FIGS. 1 and 2, the illustrated fitting 100 is configured for use in an underground irrigation system 101. The illustrated irrigation system 101 generally includes, without limitation, a main water line 103 or pipe (e.g., constructed from polyvinyl chloride (PVC), polyethylene, etc.), a lateral line 105 or pipe (e.g., constructed from polyethylene, etc.) coupled to the main line 103 by the fitting 100, and a sprinkler head 107 coupled to the lateral line 105. As described, the fitting 100 is configured to be press-fit (e.g., manually by a user, etc.) onto the main line 103 of the irrigation system 101 to provide a fluid connection between the main line 103 and the lateral line 105. As such, in operation of the irrigation system 101, water can flow from the main line 103, through the fitting 100, and through the lateral line 105 to the sprinkler head 107 for directing the water to vegetation as desired.

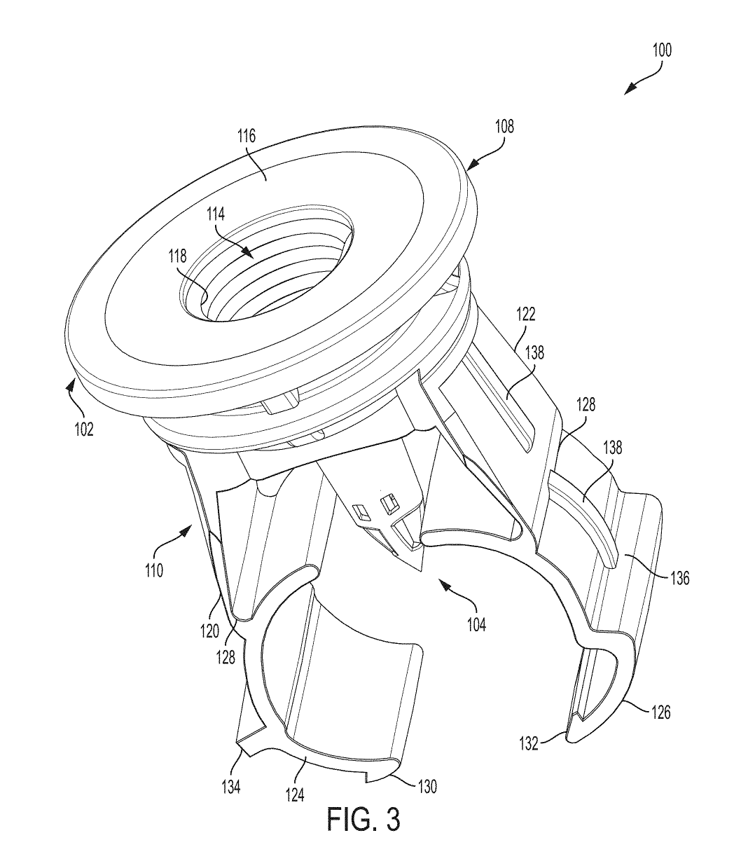

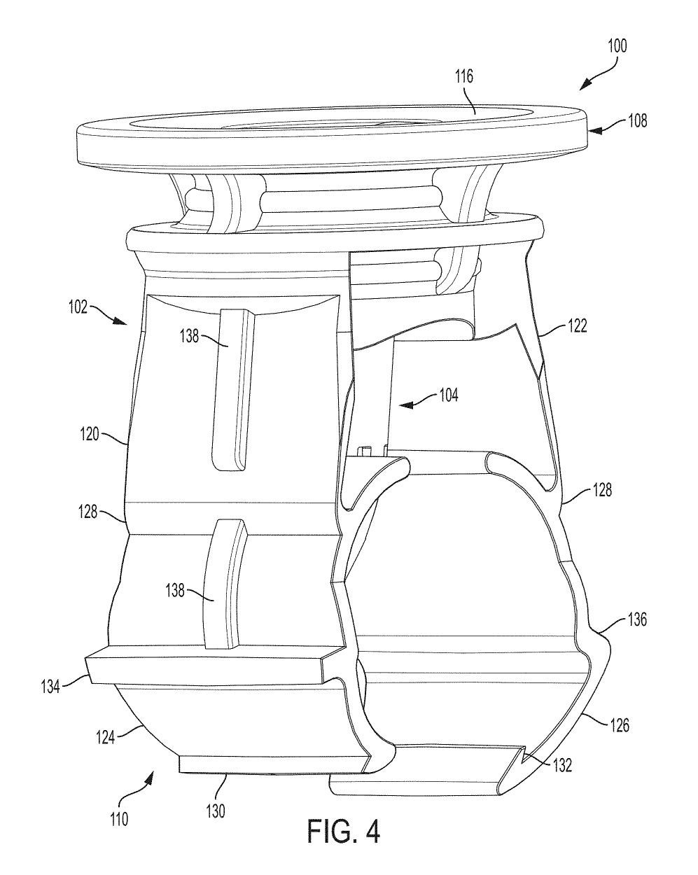

With reference now to FIGS. 3 and 4, the illustrated fitting 100 generally includes a saddle 102 and a tap 104 extending generally downwardly from the saddle 102. The saddle 102 and the tap 104 of the illustrated fitting 100 are formed as a single structure. The fitting 100 can thus be press-fit (e.g., manually by users, etc.) onto the main line 103 of the irrigation system to establish the fluid connection, without threading or rotating the fitting 100 and without threading or rotating the tap 104 relative to the saddle 102 (as in conventional fittings) in order to install the fitting 100 to the main line 103. While the fitting 100 is generally described herein with reference to the main line 103, it should be appreciated that the fitting 100 may be used with other pipes (i.e., pipes other than main lines) within the scope of the present disclosure.

As shown in the irrigation system 101, in use, the saddle 102 is configured to fit over the main line 103 and couple the fitting 100 thereto. And, at the same time, the tap 104 is configured to pierce the main line 103 and make the fluid connection between the main line 103 and one or more other devices coupled to the fitting 100, such as the lateral line 105 and the sprinkler head 107 in the system 101. In addition, when pushing the fitting 100 onto the main line 103 (and, in particular, when pushing the tap 104 into the main line 103 to pierce the main line 103), the saddle 102 helps hold the main line 103 and inhibit the main line 103 from flattening (or crushing) under the pushing force applied to the fitting 100 and the tap 104 (and thus helps facilitate piercing the tap 104 into the main line 103). As such, when the fitting 100 is installed to the main line 103, fluid in the main line 103 can flow through the tap 104 and the saddle 102 to the one or more other devices coupled to the fitting 100.

As previously indicated, in the illustrated embodiment the saddle 102 and the tap 104 of the fitting 100 are integrally, monolithically, etc. formed (e.g., molded, etc.) as one piece, one structure, etc. to define the fitting 100. Alternatively, the saddle 102 and the tap 104 could be formed separately and then subsequently coupled together as desired (e.g., welded together, mechanically coupled together, epoxied together, etc.) to form the fitting 100 (still, generally, as a one-piece structure). In addition, the fitting 100 can be constructed from any suitable material within the scope of the present disclosure including, for example, plastics, metals, combinations thereof, etc.

Also in the illustrated embodiment, the fitting 100 is configured generally as a saddle tee fitting for use in irrigation systems (e.g., the irrigation system 100, etc.). However, it should be appreciated that aspects of the present disclosure may also apply to other fittings (e.g., fittings other than saddle tee fittings, etc.) within the scope of the present disclosure. In addition, it should be appreciated that aspects of the present disclosure may also be implemented in applications other than those involving irrigation systems (e.g., other systems requiring fittings coupled to pipes to make fluid connections between the pipes such as, for example, plumbing systems, etc.) within the scope of the present disclosure. Also in the illustrated embodiment, the fitting 100 and the tap 104 are generally straight in shape. In other example embodiments, fittings may include taps with other shapes (or the fittings themselves may have other shapes) such as, for example, elbow shapes, S-shapes, T-shapes, Y-shapes, etc. and/or taps having other sizes than illustrated herein.

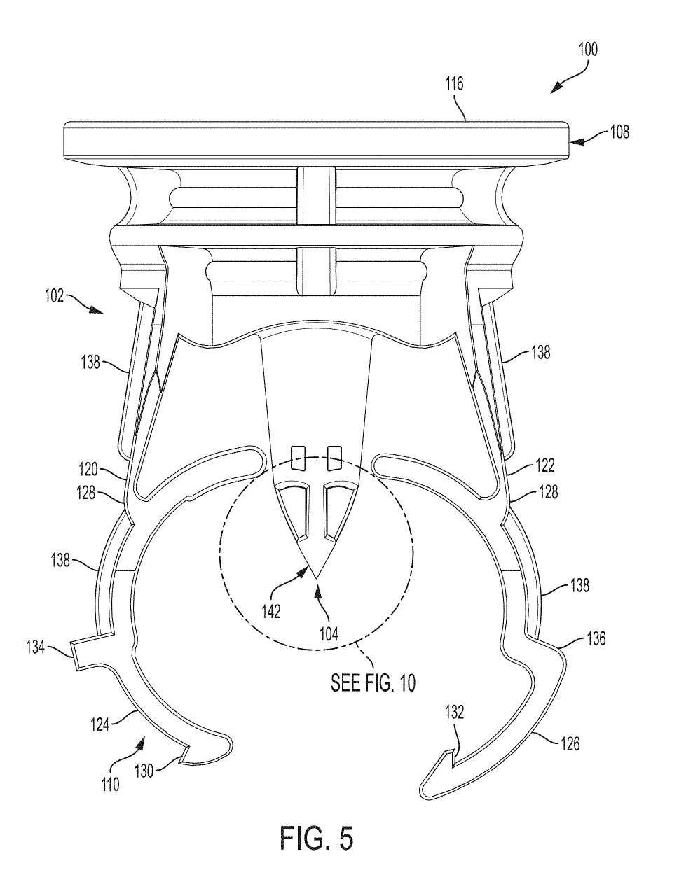

With additional reference to FIGS. 5-7, the saddle 102 of the fitting 100 includes a body 108 and a clamp 110. The clamp 110 is disposed generally below the body 108, and operates to hold the fitting 100 on the main line 103. In the illustrated fitting 100, the body 108 and the clamp 110 are integrally formed as one structure to define the saddle 102. Alternatively, the body 108 and the clamp 110 could be formed separately and then subsequently coupled together (e.g., welded together, mechanically coupled together, epoxied together, etc.) to form the saddle 102.

The body 108 of the saddle 102 is generally short and tubular in shape (although other sizes and/or shapes may be used within the scope of the present disclosure). A channel 114 (FIG. 3) extends generally longitudinally through the body 108 and into the tap 104 to provide fluid communication through the fitting 100. An upper end portion of the channel 114, located toward an upper surface 116 of the body 108, is configured (e.g., includes threads 118 as is conventional, etc.) to couple one or more other devices to the fitting 100 (e.g., the sprinkler head 107, etc.), for example, via flexible tubing (such as lateral line 105), funny pipe, etc., to establish the fluid communication between the fitting 100 and the one or more other devices. In addition, the upper surface 116 of the body 108 is also broad and substantially flat, to help facilitate manually pushing the fitting 100 (via the upper surface 116) into connection with the main line 103. As can be appreciated, this broad and substantially flat shape may provide a conducive surface to allow a user to provide sufficient force to push the fitting 100 onto the main line 103 (and to push the tap 104 into the main line 103), and help inhibit fatigue and/or discomfort to the user when doing so. Alternatively, the shape of the upper surface 116 of the body 108 may be substantially concave or convex (e.g., with no rough edges and/or corners, etc.).

The clamp 110 of the saddle 102 includes first and second arms 120, 122 extending generally away from the body 108, and jaw portions 124, 126 coupled to the arms 120, 122. The jaw portions 124, 126 are each generally arcuate in shape, and are each coupled to corresponding arms 120, 122 by hinges 128 (e.g., living hinges, mechanical hinges, etc.). This allows the jaw portions 124, 126 to move, flex, etc. relative to the arms 120, 122 when positioning the main line 103 between the jaw portions 124, 126 (e.g., in preparation for coupling the saddle 102 to the main line 103, etc.). Lips 130, 132 are provided on lower end portions of the jaw portions 124, 126, respectively, for use in holding, securing, etc. the jaw portions 124, 126 together when coupling the saddle 102 to the main line 103. For example, the lower end portions of the jaw portions 124, 126 can be pushed together (flexing at the hinges) until the lips 130, 132 engage and secure the jaw portions 124, 126 together.

In the illustrated embodiment, the jaw portion 124 coupled to the first arm 120 also includes an outer tab 134, and the jaw portion 126 coupled to the second arm 122 also includes a shoulder 136. The tab 134 and the shoulder 136 provide regions for grasping the jaw portions 124, 126 (e.g., by hand, with a tool (e.g., pliers, etc.), etc.) to move the jaw portions 124, 126 together to engage the lips 130, 132. In addition, ribs 138 are formed on the arms 120, 122 to help reinforce the arms 120, 122 against stresses resulting from flexing, moving, etc. the jaw portions 124, 126 relative to the arms 120, 122 (e.g., when coupling the saddle 102 to the main line 103, etc.).

Also in the illustrated embodiment, the jaw portions 124, 126 are coupled to the arms 120, 122 at locations generally between end portions of the jaw portions 124, 126 (e.g., at locations about one third of a distance from upper end portions of the jaw portions 124, 126, at locations about 0.4 inches from upper end portions of the jaw portions 124, 126, etc.). Alternatively, the jaw portions 124, 126 could be coupled to the arms 120, 122 at upper end portions of the jaw portions 124, 126 within the scope of the present disclosure. Also in the illustrated embodiment, a spacing between the first and second arms 120, 122 is generally equal to or greater than an outside diameter of the main line 103, although such a spacing is not required in all embodiments of the present disclosure.

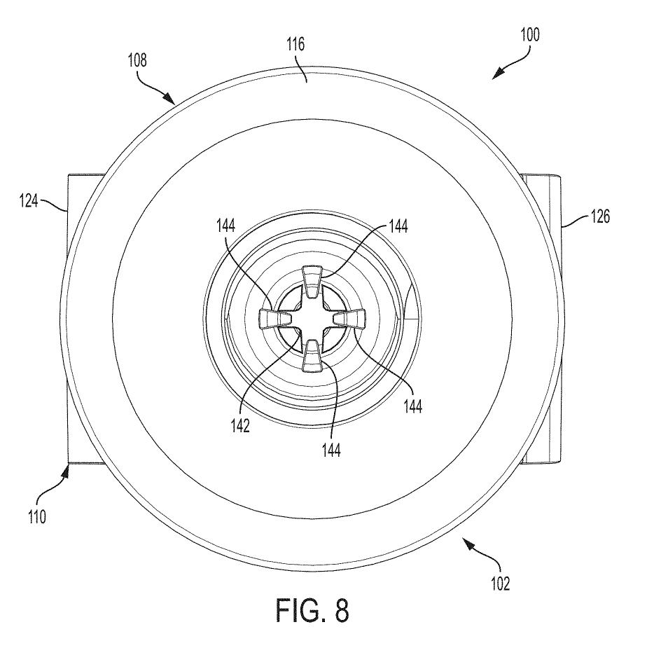

With reference now to FIGS. 8-10, the tap 104 of the fitting 100 extends generally downward from the body 108 of the saddle 102, between the arms 120, 122 of the saddle 102, and includes (or defines) part of the channel 114. The channel 114 extends generally through the tap 104, from the body 108 of the saddle 102 to a tip 142 of the tap 104, such that fluid can flow through the channel 114 from the tip 142 of the tap 104 to the body 108 of the saddle 102. Uniquely, the saddle 102 and the tap 104 both define at least part of the channel 114 (as opposed to other known fittings in which the tap 104 is positioned within the saddle 102 and defines the entire channel 114).

The illustrated tap 104 is generally linear and cylindrical in shape (although, as previously described, other shapes may be used within the scope of the present disclosure), and includes the generally spike-shaped, pointed tip 142. This configuration helps facilitate pressing, pushing, etc. movement of the tap 104 in the main line 103 (i.e., helps allow the tap 104 to be press-fit into and pierce the main line 103, as opposed to requiring rotation or other movements of the tap 104 for installation as in conventional fittings).

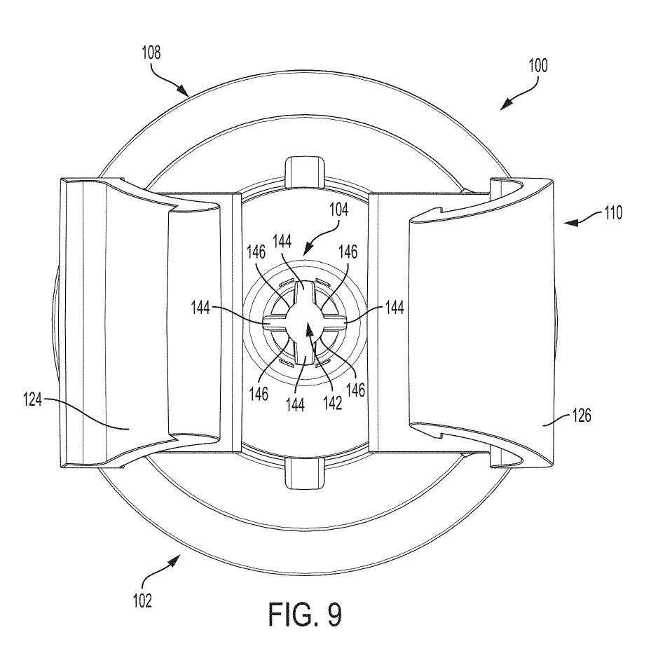

The spike-shaped tip 142 of the tap 104 generally includes a cross support. In the illustrated embodiment, the cross support is generally defined by four dividing members 144. And, an angle between adjacent ones of the dividing members 144 is about 90 degrees. As such, the dividing members 144 define a generally cross shape when viewed, for example, from above (FIG. 8) or from below (FIG. 9). In other exemplary embodiments, fittings may include taps with tips defining cross supports formed by other configurations of dividing members (e.g., configurations having two dividing members, three dividing members, five dividing members, greater than five dividing members, etc.).

In the illustrated fitting 100, the dividing members 144 of the tap's cross support are integrally formed, and define a generally solid mass of material at a vertex of the tip 142. This solid construction of the tip 142 adds strength to the tap 104, and helps with piercing the main line 103 when pushing the tap 104 into the main line 103 (as compared to traditional taps in which tips are generally hollow and generally weak). This solid construction of the tip 142 also allows a sidewall of the tap 104 to be substantially thinner than in conventional taps, such that the tap 104 can actually be smaller in size (e.g., in diameter, etc.) (and, thus, easier to push through the main line 103) and still accommodate a desired flow of fluid therethrough (as compared to conventional taps used to accommodate the same fluid flow, which are generally thicker in order to accommodate the same fluid flow). As such, the cross support feature included in the illustrated fitting 100 allows the tap 104 to be pushed by hand into the main line 103 (without crushing the main line 103), while also accommodating sufficient fluid flow through the tap 104 (from the main line 103) to activate/operate one or more devices coupled to the fitting 100 (e.g., the sprinkler head 107, etc.). For example, in some embodiments, the fitting 100 is capable of accommodating fluid flow through the fitting 100 of at least about 4 gallons per minute. In some embodiments, the fitting 100 is capable of accommodating fluid flow through the fitting 100 of at least about 4.5 gallons per minute. And, in some embodiments, the fitting 100 is capable of accommodating fluid flow through the fitting 100 of at least about 5 gallons per minute.

Also in the illustrated fitting 100, the cross support of the tap 104 defines multiple windows 146 that allow fluid to flow into the tip 142, through the windows 146, and into the channel 114 extending through the tap 104 (e.g., from the main line 103 when the fitting 100 is coupled to the main line 103, etc.). In the illustrated embodiment, four windows 146 are formed generally between the four dividing members 144. And, each window 146 extends about 90 degrees around the tip 142 of the tap 104, etc. Each of the windows 146 is also generally quadrilateral in shape (although other shapes may be used within the scope of the present disclosure, for example, triangular shapes, polygonal shapes, rounded shapes, etc.). The illustrated tap 104 also includes four windows 148 (broadly, inlets) defined generally above the tip 142. The windows 148 allow additional fluid to flow into the tip 142 and into the channel 114 extending through the tap 104 (e.g., from the main line 103 when the fitting 100 is coupled to the main line 103, etc.). All of the windows 146, 148 included in the tap 104 help ensure that sufficient fluid flows through the fitting 100 for operating a component coupled thereto (e.g., to cause the sprinkler head 107 to raise for dispersing water, etc.). With that said, it should be appreciated that different numbers of windows 146, 148 may be used, for example, to help ensure that sufficient fluid flows through the fitting 100 for operating a component coupled thereto.

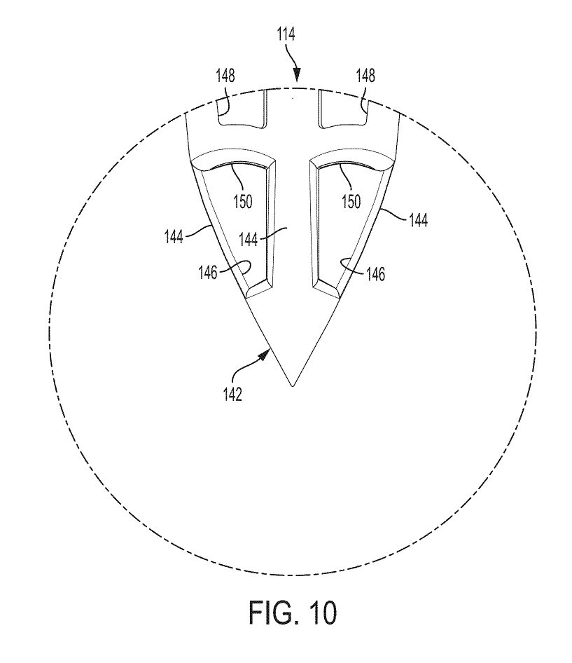

In addition, each of the windows 146 defined by the cross support of the tap 104 includes an upper edge portion 150 (as viewed in FIG. 10) that is generally arching, rounded, etc. in shape. The edge portions of each of the windows 146 are also beveled in shape generally outwardly of the tap 104. This configuration of the windows 148 (and particularly the arching, rounded, etc. shape of the upper edge portion 150 of each of the windows 148) helps reduce friction at a point of contact of the tap 104 with the main line 103 (e.g., as compared to taps having similar windows with generally straight or square upper edge portions, etc.). For example, the arching, rounded, etc. shape of the upper edge portion 150 of each of the windows 148 generally results in less abrupt points of contact of the tap 104 with the main line 103 and, therefore, inhibits requiring hard cuts to be made at the windows 148 to pierce the main line 103. In turn, these features help improve ability of the tap 104 to be pushed through, and pierce, the main line 103 using only the strength of the user pushing the tap 104 generally straight into the main line 103 (generally without rotating or threading it).

Further, the illustrated tap 104 is generally tapered in shape to help facilitate sealing the tap 104 with, against, etc. the main line 103 when establishing the fluid communication (e.g., for polyethylene pipes, etc.). However, the tap 104 could alternatively be generally strait (with no taper). In addition, in some embodiments a seal (e.g., a rubber grommet, a plastic grommet, an O-ring, etc.) may also, or alternatively, be provided around the tap 104 to help facilitate sealing the tap 104 with, against, etc. the main line 103 (e.g., such that the seal is positioned against an outer surface of the main line 103 when the fitting 100 is installed to the main line 103, etc.) (e.g., for polyethylene pipes, polyvinyl chloride pipes, etc.).

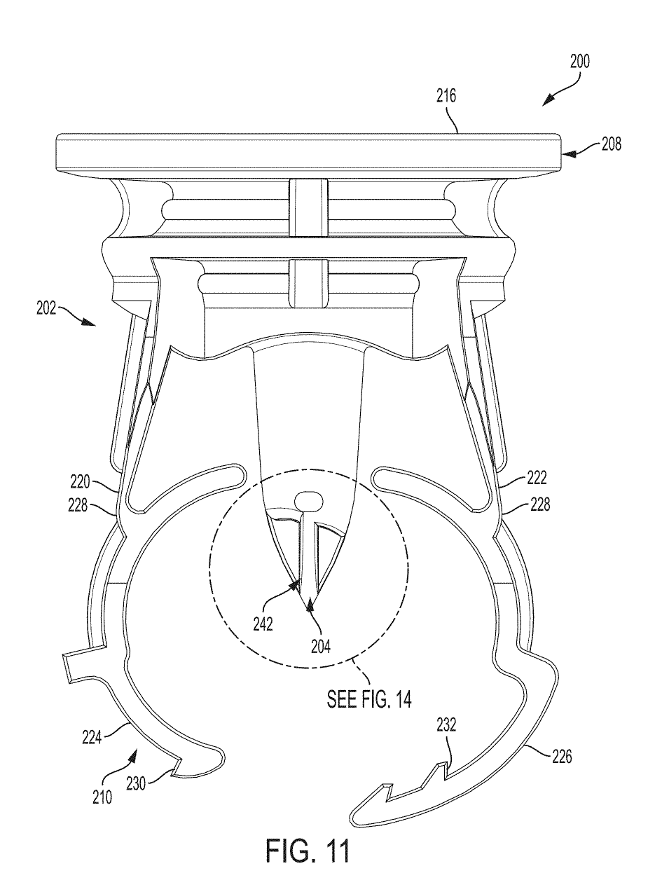

FIGS. 11-14 illustrate another exemplary embodiment of a fitting 200 including one or more aspects of the present disclosure. The fitting 200 is substantially the same as the fitting 100 previously described and illustrated in FIGS. 1-10. As such, the prior description of the fitting 100 herein also generally applies to corresponding parts of the fitting 200 of this embodiment (taking into account the following description of the fitting 200). In addition, it should be appreciated that the fitting 200 of this embodiment may similarly be used in irrigation systems or otherwise, in similar fashion to that described for the fitting 100.

With that said, the fitting 200 generally includes a saddle 202 and a tap 204 extending generally downwardly from the saddle 202. The saddle 202 and the tap 204 of the illustrated fitting 200 are formed as a single structure. And, the fitting 200 can be press-fit (e.g., manually by users, etc.) onto a pipe to establish fluid connection, without threading or rotating the fitting 200 (or any portion thereof, such as the tap 204 relative to the saddle 202) in order to install the fitting 200 to the pipe.

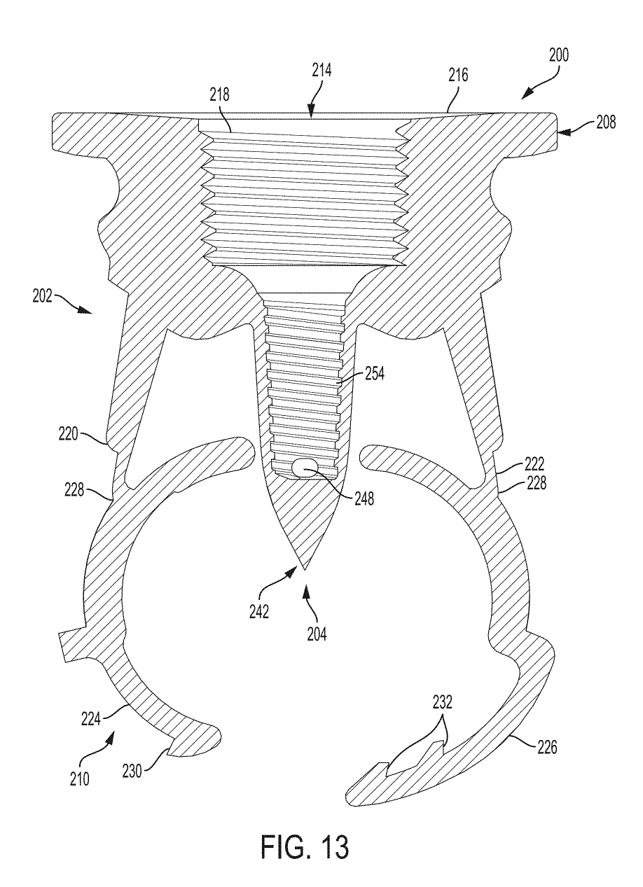

The saddle 202 of the fitting 200 includes a body 208 and a clamp 210. The body 208 is generally short and tubular in shape. And, a channel 214 (FIG. 13) is defined by both the body 208 and the tap 204 to provide fluid communication through the fitting 200. An upper end portion of the channel 214, located toward an upper surface 216 of the body 208, includes threads 218 to couple one or more other devices to the fitting 200, for example, via a connector, etc., to establish the fluid communication between the fitting 200 and the one or more other devices. A lower end portion of the channel 214, defined generally by the tap 204, also includes threads 254 that are smaller than the upper threads 218 to receive a different size connector, as desired. In addition, the upper surface 216 of the body 208 is also broad and substantially flat, to help facilitate manually pushing the fitting 200 (via the upper surface 216) into connection with a pipe.

The clamp 210 of the fitting 200 is disposed generally below the body 208, and operates to hold the fitting 200 on a pipe. The clamp 210 includes first and second arms 220, 222 extending generally away from the body 208, and jaw portions 224, 226 coupled to the arms 220, 222. The jaw portions 224, 226 are each generally arcuate in shape, and are each coupled to corresponding arms 220, 222 by hinges 228. This allows the jaw portions 224, 226 to move, flex, etc. relative to the arms 220, 222 when positioning a pipe between the jaw portions 224, 226. Lips 230, 232 are provided on lower end portions of the jaw portions 224, 226 for use in holding, securing, etc. the jaw portions 224, 226 together when coupling the saddle 202 to the pipe.

In this embodiment, the tap 204 of the fitting 200 includes a generally spike-shaped, pointed tip 242 that is somewhat different from the tip 242 of the fitting 200.

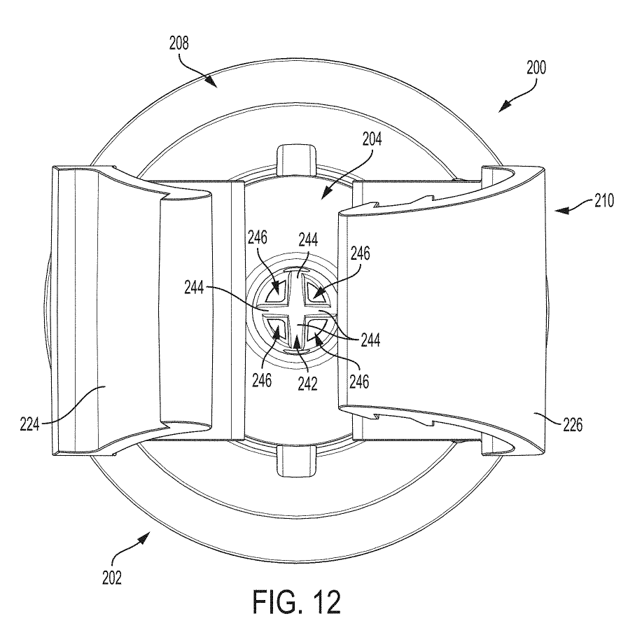

The spike-shaped tip 242 of the tap 204 includes a cross support generally defined by four dividing members 244. And, an angle between adjacent ones of the dividing members 244 is about 90 degrees. As such, the dividing members 244 define a generally cross shape when viewed, for example, from above or from below (see FIG. 12). The cross support helps provide strength to the tip 242 of the tap 204. In other exemplary embodiments, and as previously described, fittings may include taps with tips defining cross supports formed by other configurations of dividing members (e.g., configurations having two dividing members, three dividing members, five dividing members, greater than five dividing members, etc.).

The dividing members 244 of the tap's cross support are integrally formed, and define a generally solid mass of material at a vertex of the tip 242. This solid construction of the tip 242 adds strength to the tap 204, and helps with piercing a pipe when pushing the tap 204 into the pipe (as compared to traditional taps in which tips are generally hollow and generally weak). This solid construction of the tip 242 also allows a sidewall of the tap 204 to be substantially thinner than in conventional taps, such that the tap 204 can actually be smaller in size (e.g., in diameter, etc.) (and, thus, easier to push through a pipe) and still accommodate a desired flow of fluid therethrough (as compared to conventional taps used to accommodate the same fluid flow, which are generally thicker in order to accommodate the same fluid flow). As such, the cross support feature included in the illustrated fitting 200 helps allow the tap 204 to be pushed by hand into a pipe (without crushing the pipe), while also accommodating sufficient fluid flow through the tap 204 (from the pipe) to activate/operate one or more devices coupled to the fitting 200.

In addition, the cross support of the tap 204 defines windows 246 that allow fluid to flow into the tip 242, through the windows 246, and into the channel 214 extending through the tap 204 (e.g., from a pipe when the fitting 200 is coupled to the pipe, etc.). In the illustrated embodiment, four windows 246 are formed generally between the four dividing members 244. Two of the windows 246 are shown in FIG. 14, with it understood that the windows 246 on the opposite side of the tap 204 are a mirror image of the windows 246 shown in FIG. 14 (although such similarity is not required in all embodiments). And, each window 246 extends about 90 degrees around the tip 242 of the tap 204, etc. Each of the windows 246 is also generally triangular in shape (although other shapes may be used within the scope of the present disclosure, for example, quadrangular shapes, polygonal shapes, rounded shapes, etc.). The illustrated tap 204 also includes two inlets 248 defined generally above the tip 242 and disposed on generally opposite sides of the tip 242 (and in fluid communication with the windows 246 and channel 214). The inlets 248 allow additional fluid to flow into the tip 242 and the channel 214 extending through the tap 204 (e.g., from a pipe when the fitting 200 is coupled to the pipe, etc.), and help ensure that sufficient fluid flows through the fitting 200 for operating a component coupled thereto. For example, in some embodiments, the fitting 200 is capable of accommodating fluid flow through the fitting 200 of at least about 4 gallons per minute. In some embodiments, the fitting 200 is capable of accommodating fluid flow through the fitting 200 of at least about 4.5 gallons per minute. And, in some embodiments, the fitting 200 is capable of accommodating fluid flow through the fitting 200 of at least about 5 gallons per minute.

Each of the windows 246 defined by the cross support of the tap 204 includes an upper edge portion 250 (as viewed in FIG. 14) that is generally sloped or angled or slanted in shape or orientation (e.g., sloping from left to right as viewed in FIG. 14, etc.). And, a lower portion of each of the windows 246 is generally narrowed toward the tip 242 of the tap 204 (defining the generally triangular shape). As such, as viewed in FIG. 14, the right window 246 is generally smaller in size than the left widow 246 (this relation is also true for the windows 246 on the opposite side of the tap 204). The edge portions of each of the windows 246 may also be beveled in shape generally outwardly of the tap 204.

This configuration of the cross support of the tap 204 helps reduce friction at a point of contact of the tap 204 with a pipe. For example, the sloping or angling or slanting shape of the upper edge portion 250 of each of the windows 246 generally results in less abrupt points of contact of the tap 204 with the pipe and, therefore, inhibits requiring hard cuts to be made at the windows 246 to pierce the pipe. In turn, this configuration of the cross support may help improve ability of the tap 204 to be pushed through, and pierce, the pipe using only the strength of the user pushing the tap 204 generally straight into the pipe (generally without rotating or threading it).

Further, the illustrated tap 204 is generally tapered in shape to help facilitate sealing the tap 204 with, against, etc. a pipe when establishing the fluid communication (e.g., for polyethylene pipes, etc.). However, the tap 204 could alternatively be generally strait (with no taper). In addition, in some embodiments a seal (e.g., a rubber grommet, a plastic grommet, an O-ring, etc.) may also, or alternatively, be provided around the tap 204 to help facilitate sealing the tap 204 with, against, etc. a pipe (e.g., such that the seal is positioned against an outer surface of the pipe when the fitting 200 is installed to the pipe, etc.) (e.g., for polyethylene pipes, polyvinyl chloride pipes, etc.).

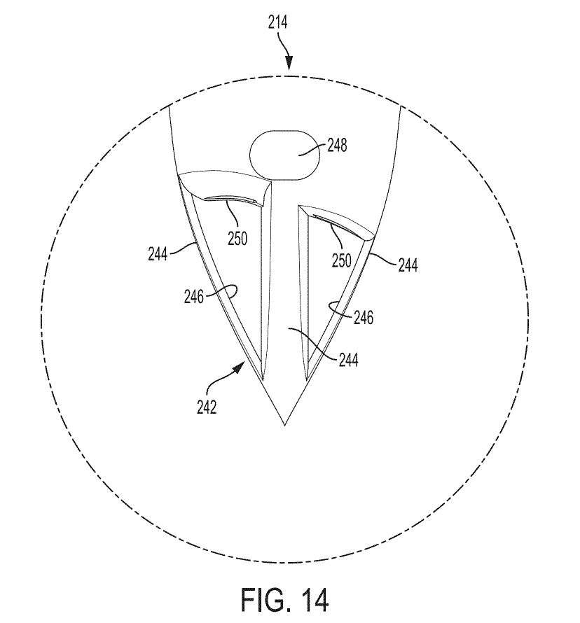

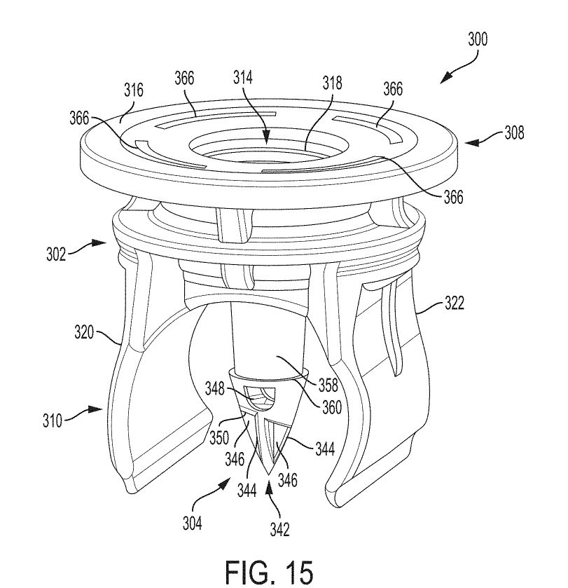

FIGS. 15-17 illustrate another exemplary embodiment of a fitting 300 including one or more aspects of the present disclosure. The fitting 300 is substantially the same as the fittings 100, 200 previously described and illustrated in FIGS. 1-10 and FIGS. 11-14. As such, the prior description of the fittings 100, 200 herein also generally apply to corresponding parts of the fitting 300 of this embodiment. In addition, it should be appreciated that the fitting 300 of this embodiment may similarly be used in irrigation systems or otherwise, in similar fashion to that described for the fittings 100, 200.

With that said, the fitting 300 generally includes a saddle 302 and a tap 304 extending generally downwardly from the saddle 302. The saddle 302 and the tap 304 of the illustrated fitting 300 are formed as a single structure. And, the fitting 300 can be press-fit (e.g., manually by users, etc.) onto a pipe to establish fluid connection, without threading or rotating the fitting 300 (or any portion thereof, such as the tap 304 relative to the saddle 302) in order to install the fitting 300 to the pipe.

The saddle 302 of the fitting 300 includes a body 308 and a clamp 310. The body 308 is generally short and tubular in shape. And, a channel 314 is defined by both the body 308 and the tap 304 to provide fluid communication through the fitting 300. An upper end portion of the channel 314, located toward an upper surface 316 of the body 308, includes threads 318 to couple one or more other devices to the fitting 300, for example, via a connector, etc., to establish the fluid communication between the fitting 300 and the one or more other devices. In addition, the upper surface 316 of the body 308 is also broad and substantially flat, to help facilitate manually pushing the fitting 300 (via the upper surface 316) into connection with a pipe.

The clamp 310 of the fitting 300 is disposed generally below the body 308, and operates to support the fitting 300 on a pipe, for example, when inserting the tap 304 into the pipe. In this embodiment, the clamp 310 includes first and second arms 320, 322 extending generally away from the body 308 (but does not include jaw portions coupled to the arms 320, 322). The arms 320, 322 are each generally arcuate in shape, and are each coupled to the body 308 so that the arms 320, 322 can slightly move, flex, etc. relative to the body 308 when positioning a pipe between the arms 320, 322. The arms 320, 322 operate to support a pipe, when installing the fitting 300 to the pipe, and help maintain a rounded shape of the pipe when inserting the tap 304 into the pipe (e.g., to help inhibit the pipe from flattening out when inserting the tap 304, etc.). And, when the fitting 300 is installed to a pipe, the arms 320, 322 help support the fitting 300 against rotation or other movement relative to the pipe, for example, when coupling a connector to the fitting 300, etc.

The tap 304 of the fitting 300 includes a generally spike-shaped, pointed tip 342 that is similar to the tip 242 of the fitting 200. In particular, the spike-shaped tip 342 includes a cross support generally defined by four dividing members 344. And, an angle between adjacent ones of the dividing members 344 is about 90 degrees. As such, the dividing members 344 define a generally cross shape when viewed, for example, from above or from below. The cross support helps provide strength to the tip 342 of the tap 304.

The dividing members 344 of the tap's tip 342 are integrally formed, and define a generally solid mass of material at a vertex of the tip 342. This solid construction of the tip 342 adds strength to the tap 304, and helps with piercing a pipe when pushing the tap 304 into the pipe (as compared to traditional taps in which tips are generally hollow and generally weak). This solid construction of the tip 342 also allows a sidewall of the tap 304 to be substantially thinner than in conventional taps, such that the tap 304 can actually be smaller in size (e.g., in diameter, etc.) (and, thus, easier to push through a pipe) and still accommodate a desired flow of fluid therethrough (as compared to conventional taps used to accommodate the same fluid flow, which are generally thicker in order to accommodate the same fluid flow). As such, the cross support feature included in the illustrated fitting 300 helps allow the tap 304 to be pushed by hand into a pipe (without crushing the pipe), while also accommodating sufficient fluid flow through the tap 304 (from the pipe) to activate/operate one or more devices coupled to the fitting 300.

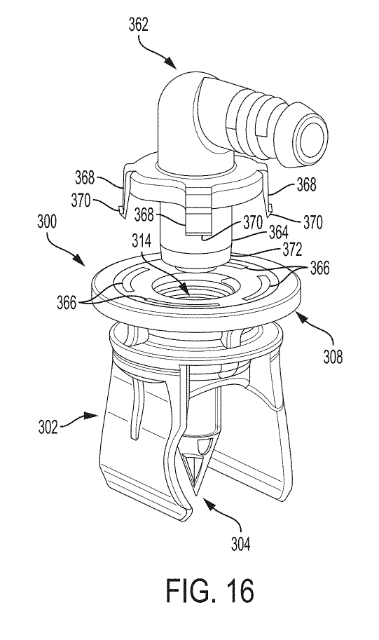

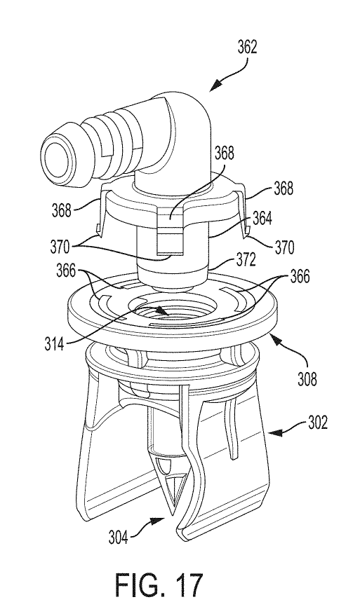

In addition, the cross support of the tap's tip 342 defines windows 346 that allow fluid to flow into the tip 342, through the windows 346, and into the channel 314 extending through the tap 304 (e.g., from a pipe when the fitting 300 is coupled to the pipe, etc.). In the illustrated embodiment, four windows 346 are formed generally between the four dividing members 344. Two of the windows 346 are shown in FIGS. 15 and 16, with it understood that the windows 346 on the opposite side of the tap 304 (as shown in FIG. 17) are a mirror image of the windows 346 shown in FIGS. 15 and 16 (although such similarity is not required in all embodiments). And, each window 346 extends about 90 degrees around the tip 342 of the tap 304, etc. Each of the windows 346 is also generally triangular in shape (although other shapes may be used within the scope of the present disclosure, for example, quadrangular shapes, polygonal shapes, rounded shapes, etc.). The illustrated tap 304 also includes two inlets 348 defined generally above the tip 342 and disposed on generally opposite sides of the tip 342 (and in fluid communication with the windows 346 and channel 314). The inlets 348 allow additional fluid to flow into the tip 342 and the channel 314 extending through the tap 304 (e.g., from a pipe when the fitting 300 is coupled to the pipe, etc.), and help ensure that sufficient fluid flows through the fitting 300 for operating a component coupled thereto. For example, in some embodiments, the fitting 300 is capable of accommodating fluid flow through the fitting 300 of at least about 4 gallons per minute. In some embodiments, the fitting 300 is capable of accommodating fluid flow through the fitting 300 of at least about 4.5 gallons per minute. And, in some embodiments, the fitting 300 is capable of accommodating fluid flow through the fitting 300 of at least about 5 gallons per minute.

Each of the windows 346 defined by the cross support of the tap 304 includes an upper edge portion 350 (as viewed in FIG. 15) that is generally sloped or angled or slanted in shape (e.g., sloping from left to right as viewed in FIG. 15, etc.). And, a lower portion of each of the windows 346 is generally narrowed toward the tip 342 of the tap 304 (defining the generally triangular shape). As such, as viewed in FIG. 15, the right window is generally smaller in size than the left widow (this relation is also true for the windows 346 on the opposite side of the tap 304). The edge portions of each of the windows 346 may also be beveled in shape generally outwardly of the tap 304.

This configuration of the cross support of the tap 304 helps reduce friction at a point of contact of the tap 304 with a pipe. For example, the sloping or angling shape of the upper edge portion 350 of each of the windows 346 generally results in less abrupt points of contact of the tap 304 with the pipe and, therefore, inhibits requiring hard cuts to be made at the windows 346 to pierce the pipe. In turn, this configuration of the cross support may help improve ability of the tap 304 to be pushed through, and pierce, the pipe using only the strength of the user pushing the tap 304 generally straight into the pipe (generally without rotating or threading it).

With continued reference to FIGS. 15-17, in the illustrated embodiment, the tip 342 of the tap 304 of the fitting 300 defines a generally barbed configuration. In particular, an upper portion of the tip 342 (as viewed in FIG. 15) is generally larger in diameter than a body 358 of the tap 304, and defines a barb or ledge 360 generally above the inlets 348. In use, when the tap 304 is inserted into a pipe, the tip 342 extends into the pipe, and the barb or ledge 360 may then be configured to engage an inner surface of the pipe to help secure (e.g., lock, hold, etc.) the fitting 300 on the pipe and help inhibit inadvertent removal of the fitting 300 from the pipe. In so doing, the barb 360 also helps maintain the windows 346 and the inlets 348 within the pipe, to thereby help maintain adequate fluid communication between the pipe and the fitting 300. Further, the body 308 of the tap 304 is generally tapered in shape to help facilitate sealing the tap 304 with, against, etc. a pipe when establishing the fluid communication (e.g., for polyethylene pipes, etc.). However, the tap 304 could alternatively be generally strait (with no taper). In addition, in some embodiments a seal (e.g., a rubber grommet, a plastic grommet, an O-ring, etc.) may also, or alternatively, be provided around the body 308 of the tap 304 to help facilitate sealing the tap 304 with, against, etc. a pipe (e.g., such that the seal is positioned against an outer surface of the pipe when the fitting 300 is installed to the pipe, etc.) (e.g., for polyethylene pipes, polyvinyl chloride pipes, etc.).

Also in the illustrated embodiment, and as shown in FIGS. 16 and 17, a connector 362 is provided for coupling to the fitting 300. In particular in this embodiment, the fitting 300 and the connector 362 are configured for making a quick-connect coupling therebetween (e.g., without using, or as an alternative to using, the conventional threads 318, etc.), when an inlet portion 364 of the connector 362 is positioned within an upper end portion of the channel 314 of the fitting 300 (e.g., the fitting 300 and the connector 362 include a quick-connect coupling, etc.). While the connector 362 is shown as a funny-pipe elbow connector, it should be appreciated that such quick-connect coupling may be used between the fitting 300 and any desired style of connector within the scope of the present disclosure.

To facilitate the coupling between the fitting 300 and the connector 362, the upper surface 316 of the body 308 of the fitting 300 includes slots 366 (broadly, openings) (also referred to as quick-connect openings) positioned generally around a perimeter of the upper surface 316 of the body 308, and the connector 362 includes corresponding tabs 368 (also referred to as quick-connect protrusions) configured to snap-fit within the slots 366. In particular, the tabs 368 include protrusions 370 that extend through the slots 366 and position generally below the upper surface 316 of the fitting body 308 when the connector 362 is positioned on the fitting 300, to help secure the connector 362 on the fitting 300. The connector 362 also includes a seal 372 (e.g., a rubber grommet, a plastic grommet, an O-ring, etc.) disposed around the inlet portion 364 thereof. When the protrusions 370 are located generally below the upper surface 316 of the body 308, the seal 372 is moved into position against an inner portion of the fitting channel 314 to further help facilitate sealing the connector 362 with, against, etc. the fitting 300. The connector 362 can then be removed from the fitting 300, as desired, by manipulating the protrusions 370 and moving the tabs 368 out of the slots 366.

In the illustrated embodiment, the upper surface 316 of the fitting body 308 includes four slots 366 and the connector 362 includes four tabs 368. In other embodiments, however, in connection with providing quick-connect couplings between fittings and connectors, the fittings may include bodies with more than or less than four slots for receiving tabs of the connectors, and/or the connectors may include more than or less than four tabs for mating with slots of the fittings. In addition, in other embodiments, in connection with providing quick-connect couplings between fittings and connectors, the fittings may include tabs extend therefrom and the connectors may include slots configured to receive the tabs of the fittings therein (e.g., in a snap-fit manner, etc.). Further, in other embodiments, other quick-connect features may be used to couple fittings and connectors, for example, tabs and slots configured to lock, secure, etc. when the tabs slide into the slots, etc.

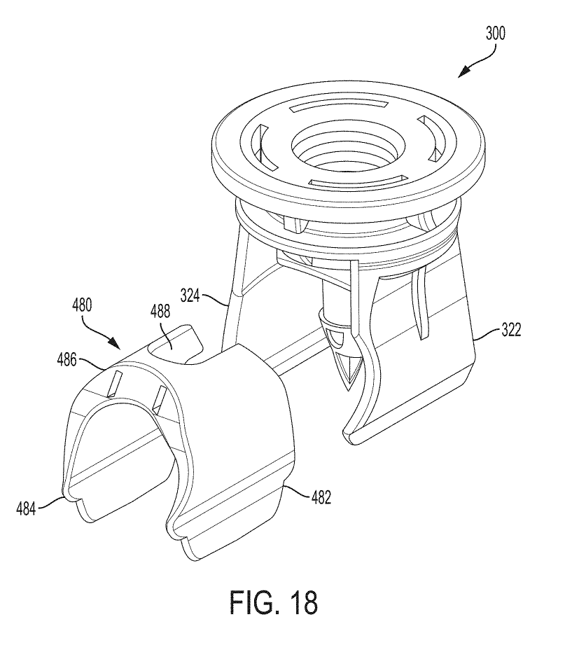

FIG. 18 illustrates an exemplary embodiment of a spacer 480 suitable for use with the fitting 300 of FIGS. 15-17, and including one or more aspects of the present disclosure. The spacer 480 is configured to allow the fitting 300 to be used with different sizes of pipes. While the spacer 480 is described in connection with the fitting 300, it should be appreciated that the spacer 480 can also be used with other ones of the fittings described herein (e.g., fitting 100, fitting 200, fitting 500, etc.).

The illustrated spacer 480 generally includes first and second arms 482, 484 extending generally away from a body 486. The arms 482, 484 are each generally arcuate in shape, and are each coupled to the body 486 so that the arms 482, 484 can slightly move, flex, etc. relative to the body 486 when positioning the spacer 480 over a pipe (and when positioning the pipe between the arms 482, 484). The arms 482, 484 operate to secure the spacer 480 on the pipe, help inhibit unwanted movement of the space relative to the pipe.

In use, the spacer 480 is coupled to a pipe, with the pipe positioned generally between the arms 482, 484 of the spacer 480. And, the fitting 300 is then positioned over the spacer 480 and pressed onto the pipe, in the manner previously described. In so doing, the arms 320, 322 of the fitting 300 generally align with the arms 482, 484 of the spacer 480, and the tap 304 of the fitting 300 generally extends through an opening 488 defined by the body 486 of the spacer 480. Thus, the spacer 480 can allow the fitting 300 to be used with a smaller diameter pipe than potentially accommodated by the fitting 300 alone.

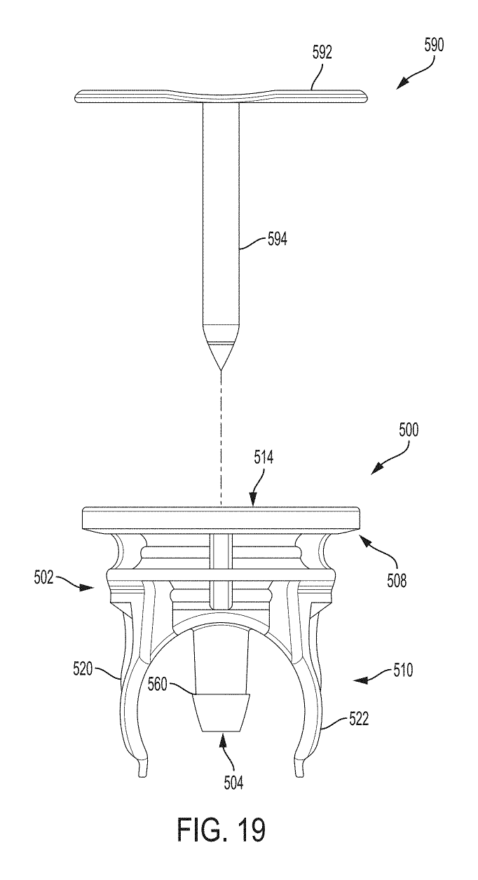

FIG. 19 illustrates another exemplary embodiment of a fitting 500 including one or more aspects of the present disclosure. The fitting 500 is similar to the fitting 300 previously described and illustrated in FIGS. 15-17. As such, the prior description of the fitting 300 (as well as the descriptions of the fittings 100, 200) herein also generally applies to corresponding parts of the fitting 500 of this embodiment. In addition, it should be appreciated that the fitting 500 of this embodiment may similarly be used in irrigation systems or otherwise, in similar fashion to that described for the fittings 100, 200, 300.

With that said, the fitting 500 generally includes a saddle 502 and a tap 504 extending generally downwardly from the saddle 502. The saddle 502 and the tap 504 of the illustrated fitting 500 are formed as a single structure. And, the fitting 500 can be press-fit onto a pipe using a press 590 to establish fluid connection, without threading or rotating the fitting 500, or without threading or rotating the tap 504 relative to the saddle 502, or without treading or rotating the press 590.

The saddle 502 of the fitting 500 includes a body 508 and a clamp 510. The body 508 is generally short and tubular in shape. And, a channel 514 is defined by both the body 508 and the tap 504 to provide fluid communication through the fitting 500. An upper end portion of the channel 514, located toward an upper surface of the body 508, may include threads to couple one or more other devices to the fitting 500, for example, via a connector, etc., to establish the fluid communication between the fitting 500 and the one or more other devices. Additionally, or alternatively, the upper surface of the body 508 may include slots to facilitate a quick-connect coupling between the fitting 500 and one or more other devices (such as described for fitting 300).

The clamp 510 of the fitting 500 is disposed generally below the body 508, and operates to support the fitting 500 on a pipe, for example, when inserting the tap 504 into the pipe. The clamp 510 includes first and second arms 520, 522 extending generally away from the body 508 (but does not include jaw portions coupled to the arms 520, 522). The arms 520, 522 are each generally arcuate in shape, and are each coupled to the body 508 so that the arms 520, 522 can slightly move, flex, etc. relative to the body 508 when positioning a pipe between the arms 520, 522. The arms 520, 522 operate to support a pipe, when installing the fitting 500 to the pipe, and help maintain a rounded shape of the pipe when inserting the tap 504 into the pipe (e.g., to help inhibit the pipe from flattening out when inserting the tap 504, etc.). And, when the fitting 500 is installed to a pipe, the arms 520, 522 help support the fitting 500 against rotation or other movement relative to the pipe, for example, when coupling a connector to the fitting 500, etc.

In this embodiment, the tap 504 of the fitting 500 does not include a spike-shaped tip. Instead, a lower portion of the tap 504 is generally open, and defines a generally lower portion of the channel 514 extending through the fitting 500. In addition, the lower portion of the tap 504 defines a generally barbed configuration. In particular, the tap 504 defines a barb or ledge 560 generally above the open end portion. In use, when the tap 504 is inserted into a pipe, the open end portion extends into the pipe, and the barb or ledge 560 may then be configured to engage an inner surface of the pipe to help secure (e.g., lock, hold, etc.) the fitting 500 on the pipe and help inhibit inadvertent remove of the fitting 500 from the pipe. Further, the body 508 of the tap 504 is generally tapered in shape to help facilitate sealing the tap 504 with, against, etc. a pipe when establishing the fluid communication (e.g., for polyethylene pipes, etc.). However, the tap 504 could alternatively be generally strait (with no taper). In addition, in some embodiments a seal (e.g., a rubber grommet, a plastic grommet, an O-ring, etc.) may also, or alternatively, be provided around the body 508 of the tap 504 to help facilitate sealing the tap 504 with, against, etc. a pipe (e.g., such that the seal is positioned against an outer surface of the pipe when the fitting 500 is installed to the pipe, etc.) (e.g., for polyethylene pipes, polyvinyl chloride pipes, etc.).

Further in this embodiment, the press 590 includes a handle portion 592 and a spike 594 extending away from the handle portion 592. In use, the spike 594 of the press 590 is positioned through the channel 514 of the fitting 500, with a pointed tip of the spike 594 extending through the open end portion of the fitting 500. The fitting 500 and press 590 are then positioned over a pipe, and the handle portion 592 of the press 590 is pushed against the fitting 500 so that the pointed tip pierces the pipe. The press 590 and fitting 500 are then further pushed toward the pipe to insert the tap 504 of the fitting 500 into the pipe through the opening made by the spike 594. The press 590 can then be removed from the fitting 500 by simply pulling the press 590 out of the channel 514 of the fitting 500. The handle portion 592 of the press 590 is generally broad and substantially flat, to help facilitate manually pushing the press 590 and fitting 500 into connection with a pipe.

It should be appreciated that other presses may be used in connection with installing the fitting 500 to a pipe, other than press 590. For example, presses utilizing two handles pivotally coupled together, with one of the handles including a spike for piercing a pipe, may be used, etc. (e.g., such as the Panther Drill from Prakor®, etc.).

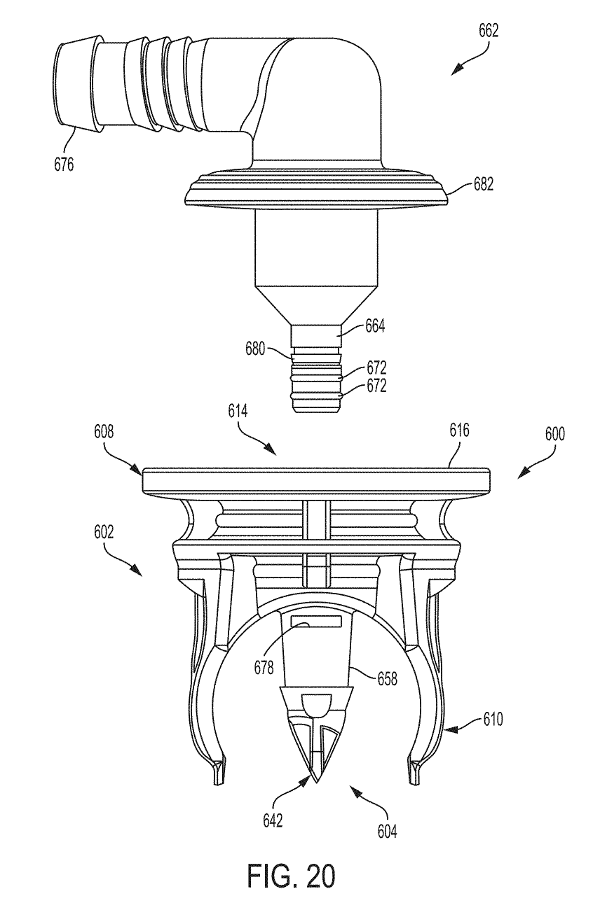

FIGS. 20-22 illustrate an exemplary embodiment of an assembly comprising a fitting 600, and a connector 662 configured to couple to the fitting 600 (and each including one or more aspects of the present disclosure). The fitting 600 of this embodiment is substantially the same as the fitting 300 previously described and illustrated in FIGS. 15-17. As such, the prior description of the fitting 300, as well as the prior descriptions of the fittings 100, 200, also generally apply to corresponding parts of the fitting 600 of this embodiment.

With that said, as shown in FIG. 20, the fitting 600 generally includes a saddle 602 and a tap 604 extending generally downwardly from the saddle 602. The saddle 602 and the tap 604 are formed as a single structure. And, the fitting 600 can be press-fit (e.g., manually by users, etc.) onto a pipe to establish fluid connection, without threading or rotating the fitting 600 (or any portion thereof, such as the tap 604 relative to the saddle 602) in order to install the fitting 600 to the pipe.

The saddle 602 of the fitting 600 includes a body 608 and a clamp 610. A channel 614 is defined by both the body 608 and the tap 604 to provide fluid communication through the fitting 600 (with the channel extending through the body 608 and into the tap 604). In addition, an upper surface 616 of the body 608 is broad and substantially flat, to help facilitate manually pushing the fitting 600 (via the upper surface 616) into connection with a pipe. The clamp 610 of the fitting is disposed generally below the body 608, and operates to support the fitting 600 on a pipe, for example, when inserting the tap 604 into the pipe. The clamp 610 is substantially similar to the clamp 310 of the fitting 300, such that the prior description of the clamp 310 applies to the clamp 610 (and will not be further repeated). The tap 604 of the fitting 600 includes a generally spike-shaped, pointed tip 642 (defining part of the channel 614) that is similar to the tip 342 of the fitting 300. As such, the prior description of the tip 342 applies to the tip 642, and will not be further repeated.

As also shown in FIG. 20, the connector 662 includes an elbow (or ninety-degree), funny pipe insert connector. However, it should be appreciated that the connector 662 may include any desired connector within the scope of the present disclosure (e.g., any suitable connector know to be used in irrigation systems; any connectors used to connect to fittings, sprinkler heads, drains, etc.; etc.). The illustrated connector 662 includes an inlet portion 664 for use in coupling the connector 662 to the fitting 600 (e.g., for positioning within the channel 614 of the fitting 600, etc.), and a barbed portion 676 for use in coupling the connector 662 to a pipe (e.g., flexible tubing, funny pipe, etc.). The inlet portion 664, in this embodiment, includes a generally narrowed tip portion configured to extend into the tap 604 of the fitting 600, when the connector 662 is coupled to the fitting 600. A channel (not visible in FIG. 20) extends through the connector 662, from the inlet portion 664 to the barbed portion 676 to accommodate fluid flow through the connector 662.

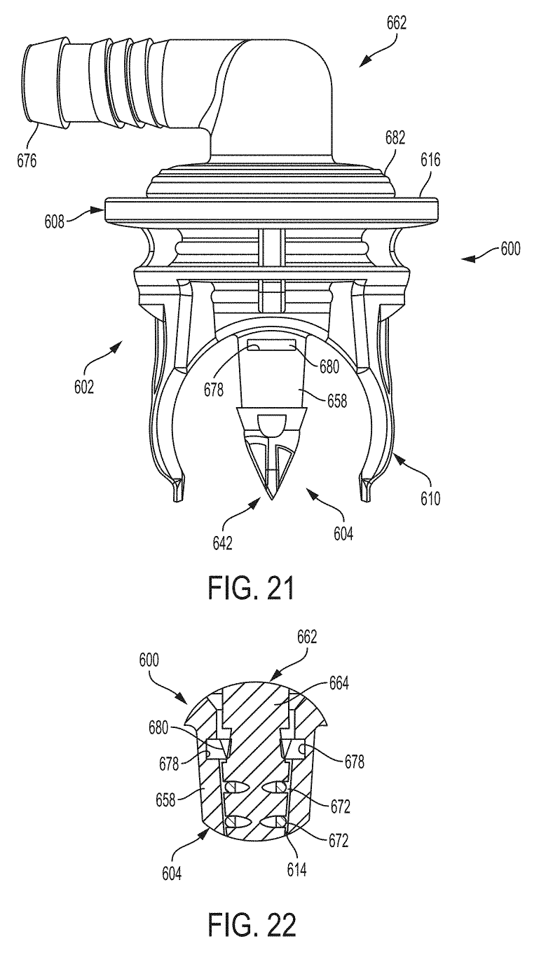

With additional reference to FIGS. 21 and 22, the fitting 600 and the connector 662 are configured to make (or establish) a quick-connect coupling therebetween (e.g., without using, or as an alternative to using, conventional threads, etc.), when the inlet portion 664 of the connector 662 is positioned within an upper end portion of the channel 614 of the fitting 600 (FIG. 21) (e.g., the fitting 600 and the connector 662 may be viewed as including a quick-connect coupling, etc.). To facilitate the quick-connect coupling, a body 658 of the tap 604 of the fitting 600 includes slots 678 (broadly, openings) (also referred to as quick-connect openings) positioned generally around a perimeter of the body 658, and the connector 662 includes a corresponding tab 680 (e.g., a ring, a locking O-ring, etc.) (also referred to as a quick-connect protrusion) extending around the inlet portion 664 and configured to generally snap-fit within the slots 678. The tab 680 is generally resilient in nature (e.g., is formed from resiliently deformable plastic, rubber, etc.) and extends (e.g., protrudes, expands, etc.) into the slots 678 when the connector 662 is positioned on the fitting 600 with the inlet portion 664 within the fitting channel 614 (FIG. 21), to help secure the connector 662 on the fitting 600. A rim 682 of the connector 662 is then also positioned generally adjacent (e.g., close to, in contact with, etc.) the upper surface 616 of the body 608 of the saddle 602 of the fitting 600, when the connection is established. The connector 662 can be removed from the fitting 600, as desired, by manipulating the tab 680 out of the slots 678.

The connector 662 also includes seals 672 (e.g., rubber grommets, plastic grommets, O-rings, etc.) disposed around the inlet portion 364 generally below the tab 680 (e.g., generally seated within channels or grooves of the inlet portion 364, etc.). When the inlet portion 664 of the connector 662 is positioned within an upper end portion of the channel 614 of the fitting 600, and the tab 680 is received within the slots 678, the seals 672 are moved into position against an inner portion of the channel 614 of the fitting 600 (FIG. 22) to further help facilitate sealing the connector 662 with, against, etc. the fitting 600.

When the connector 662 is coupled to the fitting 600, and the fitting 600 is installed to a pipe (e.g., the main line 103 in the system 101 of FIG. 1, etc.), fluid in the pipe can flow through the tap 604 and the saddle 602 (via the channel 614), and to the connector 662 (where it flows through the channel defined by/within the connector). From the connector 662, the fluid can then be distributed as desired (e.g., to another pipe coupled to the barbed portion 676 of the connector 662, etc.).

While, in this embodiment, the fitting 600 is illustrated as saddle-type fitting, it should be appreciated that the quick-connect coupling utilized between the fitting 600 and the connector 662 may be used between (or implemented in) any desired style of fitting and the connector 662 within the scope of the present disclosure (e.g., other fittings as described herein, traditional saddle tee fittings (see, e.g., U.S. Pat. No. 6,986,532, etc.), etc.). Similarly, while the connector 662 is illustrated as a funny-pipe elbow connector, it should be appreciated that the quick-connect coupling utilized between the fitting 600 and the connector 662 may be used between the fitting 600 and any desired style of connector within the scope of the present disclosure.

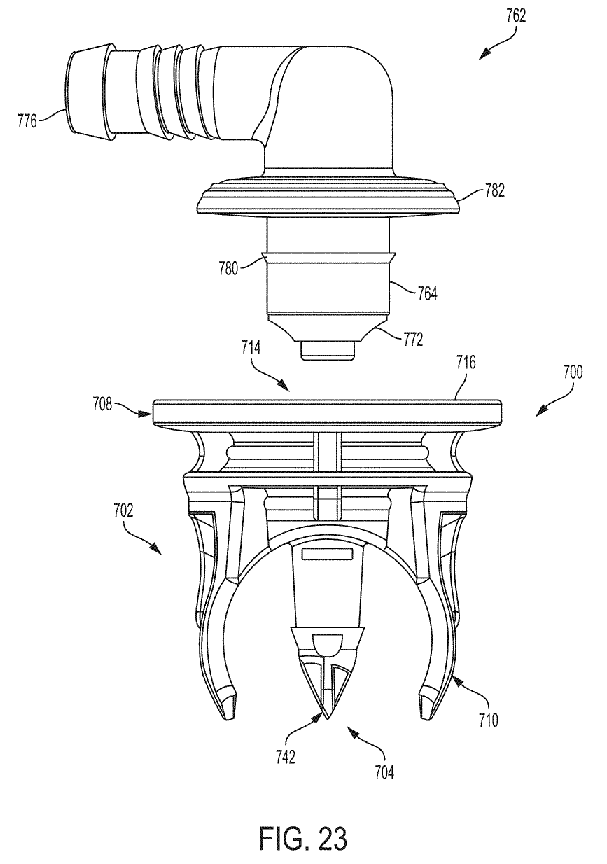

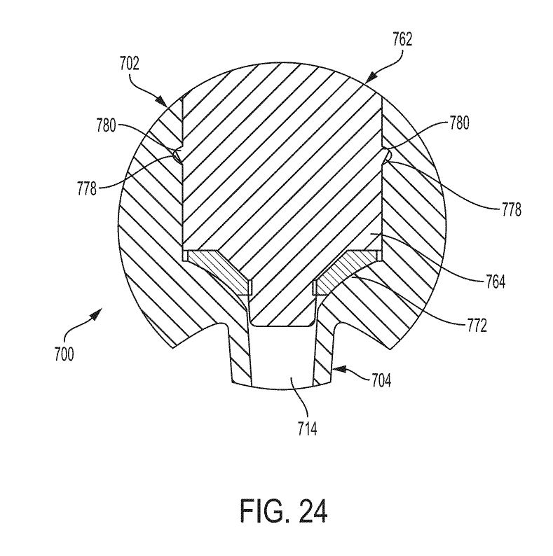

FIGS. 23 and 24 illustrate another exemplary embodiment of an assembly comprising a fitting 700, and a connector 762 configured to couple to the fitting 700 (and each including one or more aspects of the present disclosure). The fitting 700 of this embodiment is again substantially the same as the fitting 300 previously described and illustrated in FIGS. 15-17. As such, the prior description of the fitting 300, as well as the prior descriptions of the fittings 100, 200, also generally apply to corresponding parts of the fitting 700 of this embodiment.

With that said, as shown in FIG. 23, the fitting 700 generally includes a saddle 702 and a tap 704 extending generally downwardly from the saddle 702. The saddle 702 and the tap 704 are formed as a single structure. And, the fitting 700 can be press-fit (e.g., manually by users, etc.) onto a pipe to establish fluid connection, without threading or rotating the fitting 700 (or any portion thereof, such as the tap 704 relative to the saddle 702) in order to install the fitting 700 to the pipe.

The saddle 702 of the fitting 700 includes a body 708 and a clamp 710. A channel 714 is defined by both the body 708 and the tap 704 to provide fluid communication through the fitting 700. In addition, an upper surface 716 of the body 708 is broad and substantially flat, to help facilitate manually pushing the fitting 700 (via the upper surface 716) into connection with a pipe. The clamp 710 of the fitting is disposed generally below the body 708, and operates to support the fitting 700 on a pipe, for example, when inserting the tap 704 into the pipe. The clamp 710 is substantially similar to the clamp 310 of the fitting 300, such that the prior description of the clamp 310 applies to the clamp 710 (and will not be further repeated). The tap 704 of the fitting 700 includes a generally spike-shaped, pointed tip 742 that is similar to the tip 342 of the fitting 300. As such, the prior description of the tip 342 applies to the tip 742, and will not be further repeated.

The connector 762 is again illustrated as an elbow (or ninety-degree), funny pipe insert connector. However, it should be appreciated that the connector 762 may include any desired connector within the scope of the present disclosure (e.g., any suitable connector know to be used in irrigation systems; any connectors used to connect to fittings, sprinkler heads, drains, etc.; etc.). The illustrated connector 762 includes an inlet portion 764 for use in coupling the connector 762 to the fitting 700 (e.g., for positioning within the channel 714 of the fitting 700, etc.), and a barbed portion 776 for use in coupling the connector 762 to a pipe (e.g., flexible tubing, funny pipe, etc.). In this embodiment, the inlet portion 764 includes a narrowed tip portion that is generally shorter than illustrated for the connector 662 (of FIGS. 20-22), and thus that does not extend substantially into the tap 704 of the fitting 700 (see, FIG. 24).

With additional reference now to FIG. 24, the fitting 700 and the connector 762 are configured for making a quick-connect coupling therebetween (e.g., without using, or as an alternative to using, conventional threads, etc.), when the inlet portion 764 of the connector 762 is positioned within an upper end portion of the channel 714 of the fitting 700, generally within the saddle 704 (FIG. 24) (e.g., the fitting 700 and the connector 762 include a quick-connect coupling, etc.). To facilitate the quick-connect coupling, the body 708 of the saddle 702 of the fitting 700 includes a groove 778 (broadly, an opening) (also referred to as a quick-connect opening) positioned generally around an inner perimeter of the body 708, generally within the channel 714 (FIG. 24). And, the connector 762 includes a corresponding tab 780 (e.g., a ring, a locking O-ring, etc.) (also referred to as a quick-connect protrusion) extending around the inlet portion 764 and configured to generally snap-fit within the groove 778. The tab 780 is generally resilient in nature (e.g., is formed from resiliently deformable plastic, rubber, etc.) and extends (e.g., protrudes, expands, etc.) into the groove 778 when the connector 762 is positioned on the fitting 700 with the inlet portion 764 within the fitting channel 714 (FIG. 24), to help secure the connector 762 on the fitting 700. A rim 782 of the connector 762 is then also positioned generally adjacent (e.g., close to, in contact with, etc.) the upper surface 716 of the body 708 of the saddle 702 of the fitting 700. The connector 762 can then be removed from the fitting 700, as desired, by manipulating the tab 780 out of the groove 778.

The connector 762 also includes a seal 772 (e.g., a gasket, a rubber grommet, a plastic grommet, an O-ring, etc.) disposed around the inlet portion 764 generally below the tab 780. In particular, the seal 772 is located toward a tip of the inlet portion 764 and is seated about a lip portion of the inlet portion 764 (where the inlet portion 764 generally narrows in diameter). When the inlet portion 764 of the connector 762 is positioned within an upper end portion of the channel 714 of the fitting 700 (generally within the body 708 of the saddle 702 of the fitting 700), and the tab 780 is received within the groove 778, the seal 772 moves into position against an inner portion of the channel 714 of the fitting 700 (generally where a diameter of the channel 714 narrows, for example, in transition from the saddle 702 of the fitting 700 to the tap 704) (FIG. 24). In this position, the seal 772 further helps facilitate sealing the connector 762 with, against, etc. the fitting 700.

As such, when the connector 762 is coupled to the fitting 700, and the fitting 700 is installed to a pipe (e.g., the main line 103 in the system 101 of FIG. 1, etc.), fluid in the pipe can flow through the tap 704 and the saddle 702 (via the channel 714), and to the connector 762. A channel (not visible) extends through the connector 762, from the inlet portion 764 to the barbed portion 776 to accommodate fluid flow through the connector 762. As such, from the connector 762, the fluid can then be distributed as desired (e.g., to another pipe coupled to the barbed portion 776 of the connector 762, etc.).

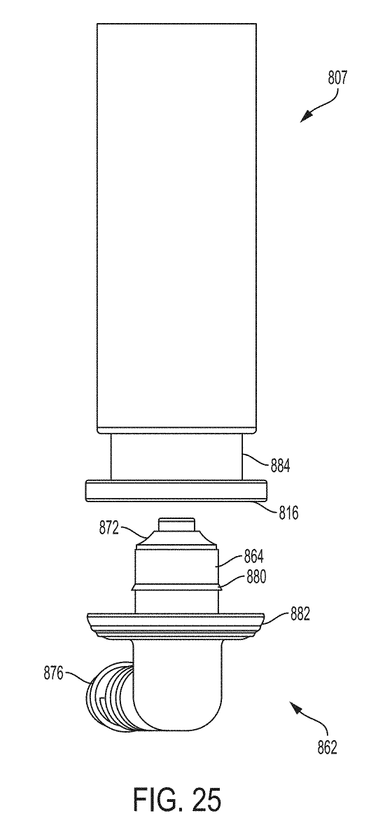

FIGS. 25-27 illustrate an exemplary embodiment of an assembly comprising a sprinkler head 807 (broadly, a fitting), and a connector 862 configured to couple to the sprinkler head 807 (and each including one or more aspects of the present disclosure).

The sprinkler head 807 is configured for use in an irrigation system (e.g., irrigation system 101, etc.), for example, to direct water to vegetation as desired. The sprinkler head 807 may include any desired sprinkler head including, for example, spray heads, rotating heads, pop-up heads, oscillating heads, etc. In addition in this embodiment, the connector 862 is again illustrated as an elbow (or ninety-degree), funny pipe insert connector, but may include any other desired connector within the scope of the present disclosure. The illustrated connector 862 includes an inlet portion 864 for use in coupling the connector 862 to the sprinkler head 807 (e.g., for positioning within a channel 814 of the sprinkler head 807, etc.), and a barbed portion 876 for use in coupling the connector 862 to a pipe (e.g., a flexible tubing, a funny pipe, etc.).

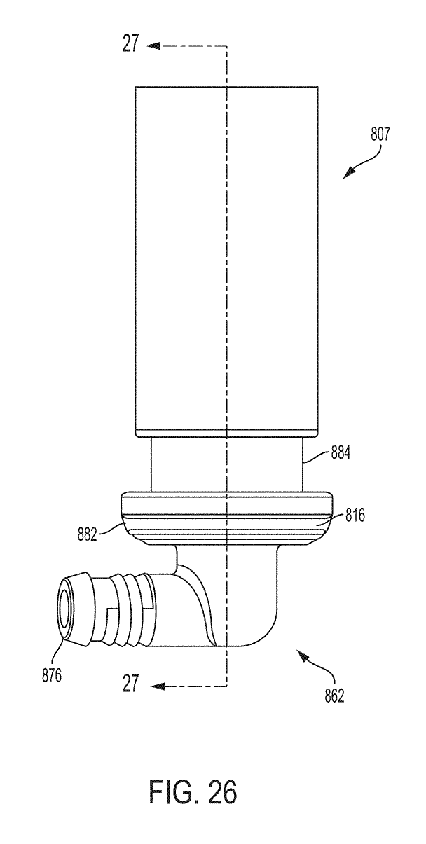

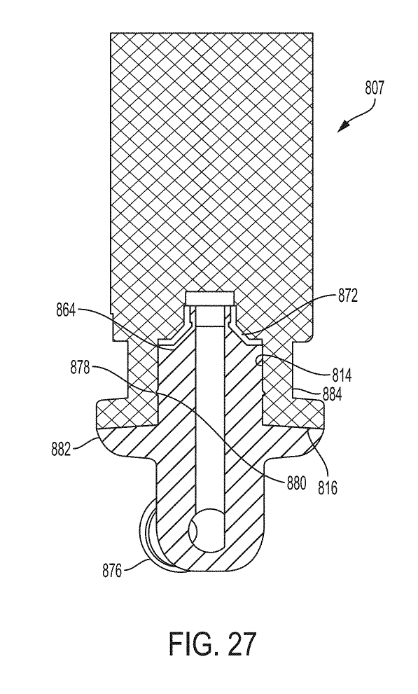

The sprinkler head 807 and the connector 862 are configured for making a quick-connect coupling therebetween (e.g., without using, or as an alternative to using, conventional threads, etc.), when the inlet portion 864 of the connector 862 is positioned within the channel 814 of the sprinkler head 807 (FIGS. 26 and 27) (e.g., the sprinkler head 807 and the connector 862 include/define a quick-connect coupling, etc.). To facilitate the quick-connect coupling, the sprinkler head 807 includes a groove 878 (broadly, an opening) (also referred to as a quick-connect opening) positioned generally around an inner perimeter of a body 884 of the sprinkler head 807, within the channel 814 (FIG. 24). And, the connector 862 includes a corresponding tab 880 (e.g., a ring, a locking ring, a locking O-ring, etc.) (also referred to as a quick-connect protrusion) extending around the inlet portion 864 and configured to generally snap-fit within the groove 878. The tab 880 is generally resilient in nature (e.g., is formed from resiliently deformable plastic, rubber, etc.) and extends (e.g., protrudes, expands, etc.) into the groove 878 when the connector 862 is positioned on the sprinkler head 807, with the inlet portion 864 within the channel 814, to help secure the connector 862 on the sprinkler head 807. A rim 882 of the connector 862 is then also positioned generally adjacent (e.g., close to, in contact with, etc.) a surface 816 of the body 884 of the sprinkler head 807, when the connection is established. The connector 862 can be removed from the sprinkler head 807, as desired, by manipulating the tab 880 out of the groove 878.

The connector 862 also includes a seal 872 (e.g., a gasket, a rubber grommet, a plastic grommet, an O-ring, etc.) disposed around the inlet portion 864 generally below the tab 880. In particular, the seal 872 is located toward a tip of the inlet portion 864 and is seated about a lip portion of the inlet portion 864 (where the inlet portion 864 generally narrows in diameter). When the inlet portion 864 of the connector 862 is positioned within the channel 814 of the sprinkler head 807, and the tab 880 is received within the groove 878, the seal 872 moves into position against an inner portion of the channel 814 (and against an inner perimeter of the body 884) of the sprinkler head 807 (generally where a diameter of the channel 814 narrows, for example) (FIG. 27). In this position, the seal 872 further helps facilitate sealing the connector 862 with, against, etc. the sprinkler head 807.

As such, when the sprinkler head 807 is coupled to the connector 862, and the connector 862 is coupled to a pipe (e.g., the lateral line 105 in the system 101 of FIG. 1, etc.), fluid in the pipe can flow through the connector 862 and to the sprinkler head 807 (at the channel 814). A channel (see FIG. 27) extends through the connector 862, from the inlet portion 864 to the barbed portion 876 to accommodate fluid flow through the connector 762. As such, from the sprinkler head 807, the fluid can be distributed as desired, for example, to vegetation, etc.

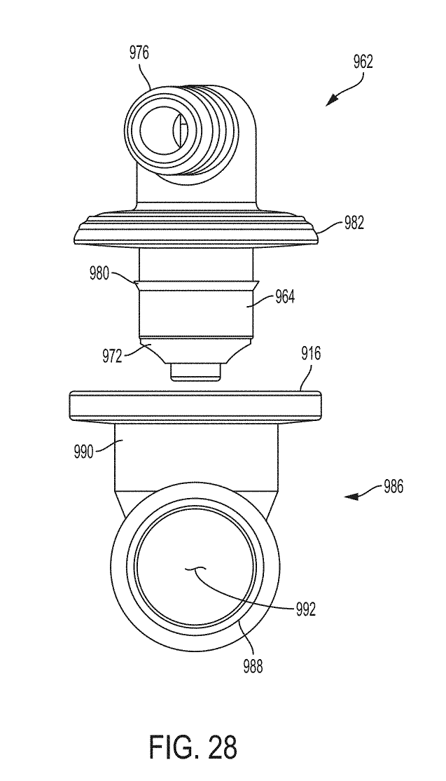

FIGS. 28-30 illustrate an exemplary embodiment of an assembly comprising a fitting 986, and a connector 962 configured to couple to the fitting 986 (and each including one or more aspects of the present disclosure).

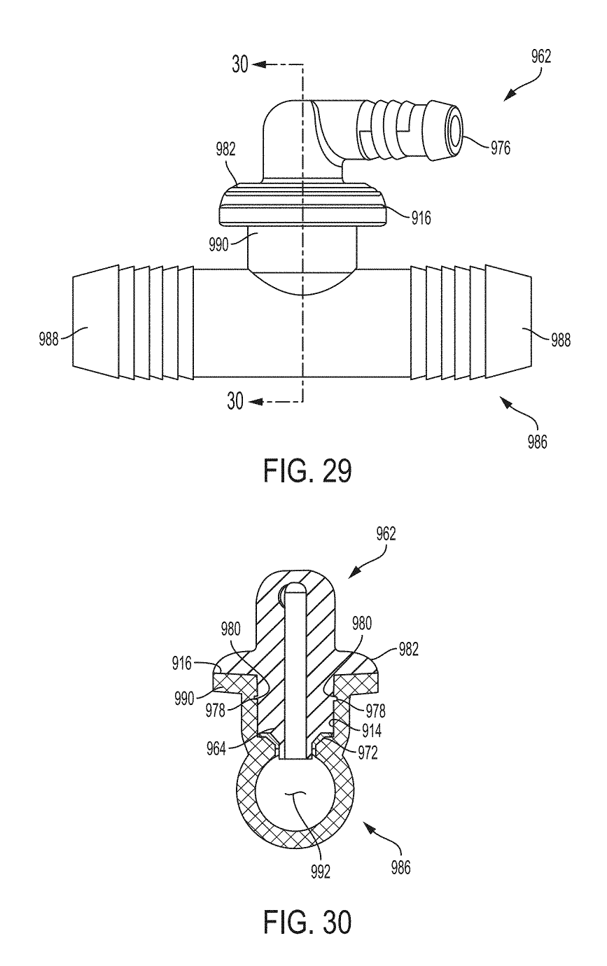

The fitting 986 is configured for use in an irrigation system (e.g., irrigation system 101, etc.), for example, to couple desired pipes together (e.g., PVC pipes, polyethylene pipes, flexible pipes, etc.). The fitting 986 includes barbed portions 988 (FIG. 29) for use in coupling the fitting 986 to the desired pipes, and a connecting portion 990 for use in coupling the fitting 986 to the connector 962. While the illustrated fitting defines a generally T shape (e.g., defines a T-fitting, etc.), it should be appreciated that fittings with other shapes/configurations may be used with the connector 962 in other embodiments (e.g., elbow fittings, Y-fittings, etc.). In addition, the connector 962 is again illustrated as an elbow (or ninety-degree), funny pipe insert connector, but may include any other desired connector within the scope of the present disclosure. The illustrated connector 962 includes an inlet portion 964 for use in coupling the connector 962 to the fitting 986 (e.g., for positioning within a channel 914 of the connecting portion 990 of the fitting 986, etc.), and a barbed portion 976 for use in coupling the connector 962 to a pipe (e.g., a flexible tubing, a funny pipe, etc.).

The connector 962 and the fitting 986 are configured for making a quick-connect coupling therebetween (e.g., without using, or as an alternative to using, conventional threads, etc.), when the inlet portion 964 of the connector 962 is positioned within the channel 914 of the connecting portion 990 of the fitting 986 (FIGS. 29 and 30) (e.g., the fitting 986 and the connector 962 are configured to form a quick-connect coupling, etc.). To facilitate the quick-connect coupling, the fitting 986 includes/defines a groove 978 (broadly, an opening) (also referred to as a quick-connect opening) positioned generally around an inner perimeter of the connecting portion 990 of the fitting 986, within the channel 914 (FIG. 30). And, the connector 962 includes a corresponding tab 980 (e.g., a ring, a locking ring, a locking O-ring, etc.) (also referred to as a quick-connect protrusion) extending around the inlet portion 964 and configured to generally snap-fit within the groove 978. The tab 980 is generally resilient in nature (e.g., is formed from resiliently deformable plastic, rubber, etc.) and extends (e.g., protrudes, expands, etc.) into the groove 978 when the connector 962 is positioned on the fitting 986, with the inlet portion 964 within the channel 914, to help secure the connector 962 on the fitting 986. Once coupled, a rim 982 of the connector 962 is positioned generally adjacent (e.g., close to, in contact with, etc.) a surface 916 of the connecting portion 990 of the fitting 986. The connector 962 can then be removed from the fitting 986, as desired, by manipulating the tab 980 out of the groove 978.

The connector 962 also includes a seal 972 (e.g., a gasket, a rubber grommet, a plastic grommet, an O-ring, etc.) disposed around the inlet portion 964 generally below the tab 980. In particular, the seal 972 is located toward a tip of the inlet portion 964 and is seated about a lip portion of the inlet portion 964 (where the inlet portion 964 generally narrows in diameter). When the inlet portion 964 of the connector 962 is positioned within the channel 914 of the connecting portion 990 of the fitting 986, and the tab 980 is received within the groove 978, the seal 972 moves into position against an inner portion of the channel 914 (and against an inner perimeter of the connecting portion 990) of the fitting 986 (generally where a diameter of the channel 914 narrows, for example, and where the channel 914 meets a lateral channel 992 extending between the barbed portions 988) (FIG. 30). In this position, the seal 972 further helps facilitate sealing the connector 962 with, against, etc. the fitting 986.

When the connector 962 is coupled to the fitting 986, and the fitting 986 is installed to desired pipes (e.g., installed within the main line 103 in the system 101 of FIG. 1, etc.), fluid in the pipe(s) can flow through the fitting 986 and to the connector 962 (via the channel 914). A channel (FIG. 30) extends through the connector 962, from the inlet portion 964 to the barbed portion 976 to accommodate fluid flow through the connector 962. As such, from the connector 962, the fluid can then be distributed as desired (e.g., to another pipe coupled to the barbed portion 976 of the connector 962, etc.).

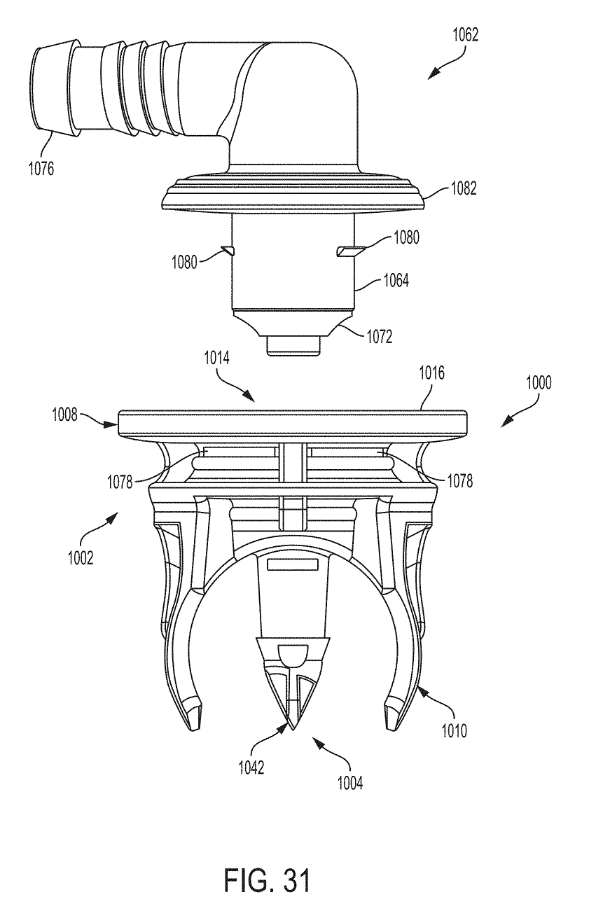

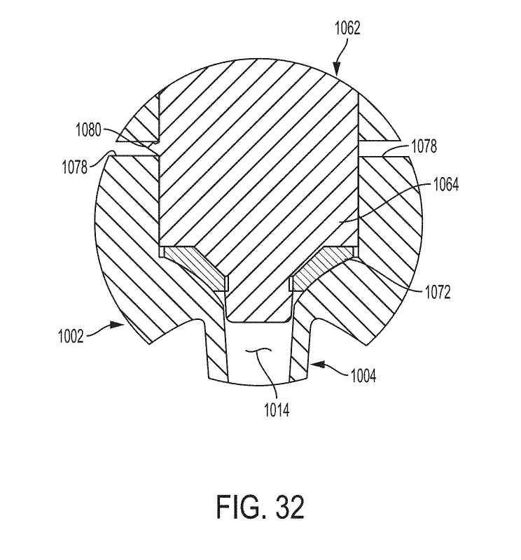

FIGS. 31 and 32 illustrate another exemplary embodiment of an assembly comprising a fitting 1000, and a connector 1062 configured to couple to the fitting 1000 (and each including one or more aspects of the present disclosure). The fitting 1000 of this embodiment is again substantially the same as the fitting 300 previously described and illustrated in FIGS. 15-17. As such, the prior description of the fitting 300, as well as the prior descriptions of the fittings 100, 200, also generally apply to corresponding parts of the fitting 1000 of this embodiment.

With that said, and as shown in FIG. 31, for example, the fitting 1000 generally includes a saddle 1002 and a tap 1004 extending generally downwardly from the saddle 1002. The saddle 1002 and the tap 1004 are formed as a single structure. And, the fitting 1000 can be press-fit (e.g., manually by users, etc.) onto a pipe to establish fluid connection, without threading or rotating the fitting 1000 (or any portion thereof, such as the tap 1004 relative to the saddle 1002) in order to install the fitting 1000 to the pipe.

The saddle 1002 of the fitting 1000 includes a body 1008 and a clamp 1010. A channel 1014 is defined by both the body 1008 and the tap 1004 to provide fluid communication through the fitting 1000 (and to the connector 1062). In addition, an upper surface 1016 of the body 1008 is broad and substantially flat, to help facilitate manually pushing the fitting 1000 (via the upper surface 1016) into connection with a pipe. The clamp 1010 of the fitting is disposed generally below the body 1008, and operates to support the fitting 1000 on a pipe, for example, when inserting the tap 1004 into the pipe. The clamp 1010 is substantially similar to the clamp 310 of the fitting 300, such that the prior description of the clamp 310 applies to the clamp 1010 (and will not be further repeated). The tap 1004 of the fitting 1000 includes a generally spike-shaped, pointed tip 1042 that is similar to the tip 342 of the fitting 300. As such, the prior description of the tip 342 applies to the tip 1042, and will not be further repeated.

As also shown in FIG. 31, the connector 1062 again includes an elbow (or ninety-degree), funny pipe insert connector. However, it should be appreciated that the connector 1062 may include any desired connector within the scope of the present disclosure (e.g., any suitable connector know to be used in irrigation systems; any connectors used to connect to fittings, sprinkler heads, drains, etc.; etc.). The illustrated connector 1062 includes an inlet portion 1064 for use in coupling the connector 1062 to the fitting 1000 (e.g., for positioning within the channel 1014 of the fitting 1000, etc.), and a barbed portion 1076 for use in coupling the connector 1062 to a pipe (e.g., flexible tubing, funny pipe, etc.).

With additional reference now to FIG. 32, the fitting 1000 and the connector 1062 are configured for making a quick-connect coupling therebetween (e.g., without using, or as an alternative to using, conventional threads, etc.), when the inlet portion 1064 of the connector 1062 is positioned within an upper end portion of the channel 1014 of the fitting 1000 (FIG. 32) (e.g., the fitting 1000 and the connector 1062 include a quick-connect coupling, etc.). To facilitate the quick-connect coupling, the body 1008 of the saddle 1002 of the fitting 1000 includes/defines openings 1078 (also referred to as quick-connect openings) positioned generally around the body 1008. And, the connector 762 includes tabs 1080 (e.g., flaps, protrusions, etc.) (also referred to as quick-connect protrusions) extending around the inlet portion 1064 and configured to generally snap-fit within corresponding ones of the openings 1078. The tabs 1080 are generally resilient in nature (e.g., are formed from resiliently deformable plastic, rubber, etc.) and extend (e.g., protrude, expand, deform, move, fold, etc.) into the openings 1078 when the connector 1062 is positioned on the fitting 1000 with the inlet portion 1064 within the fitting channel 1014 (FIG. 32), to help secure the connector 1062 on the fitting 1000. In particular, the tabs 1080 may fold or deform generally against the inlet portion 1064 when positioned within the channel 1014, and then move back (away from the inlet portion 1064) when in alignment with the openings 1078. Once coupled, a rim 1082 of the connector 1062 is positioned generally adjacent (e.g., close to, in contact with, etc.) the upper surface 1016 of the body 1008 of the saddle 1002 of the fitting 1000. The connector 1062 can then be removed from the fitting 1000, as desired, by manipulating the tabs 1080 out of the openings 1078.

The connector 1062 also includes a seal 1072 (e.g., a gasket, a rubber grommet, a plastic grommet, an O-ring, etc.) disposed around the inlet portion 1064 generally below the tabs 1080. In particular, the seal 1072 is located toward a tip of the inlet portion 1064 and is seated about a lip portion of the inlet portion 1064 (where the inlet portion 1064 generally narrows in diameter). When the inlet portion 1064 of the connector 1062 is positioned within an upper end portion of the channel 1014 of the fitting 1000 (generally within the body 1008 of the saddle 1002 of the fitting 1000), and the tabs 1080 are received within the openings 1078, the seal 1072 moves into position against an inner portion of the channel 1014 of the fitting 1000 (generally where a diameter of the channel 1014 narrows, for example, in transition from the saddle 1002 of the fitting 1000 to the tap 1004) (FIG. 32). In this position, the seal 1072 further helps facilitate sealing the connector 1062 with, against, etc. the fitting 1000.

When the connector 1062 is coupled to the fitting 1000, and the fitting 1000 is installed to a pipe (e.g., the main line 103 in the system 101 of FIG. 1, etc.), fluid in the pipe can flow through the tap 1004 and the saddle 1002 (via the channel 1014), and to the connector 1062. A channel (not visible) extends through the connector 1062, from the inlet portion 1064 to the barbed portion 1076 to accommodate fluid flow through the connector 1062. As such, from the connector 1062, the fluid can then be distributed as desired (e.g., to another pipe coupled to the barbed portion 1076 of the connector 1062, etc.).

In the illustrated embodiment, two tabs 1080 are visible on the inlet portion 1064 of the connector 1062, and two openings 1078 are visible on the saddle 1002 of the fitting 1000. It should be appreciated, however, that the connector 1062 may include any desired number of the tabs 1080 (e.g., one, three, four, five, six, ten, twenty, thirty, etc.) and/or that the fitting may include any desired number of the openings 1078 (e.g., one, three, four, five, six, ten, twenty, thirty, etc.).

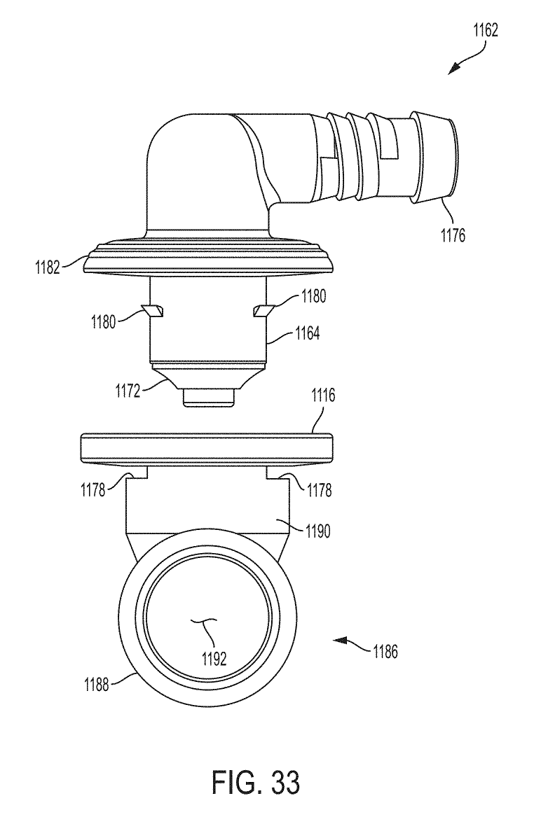

FIGS. 33-35 illustrate another exemplary embodiment of an assembly comprising a fitting 1186, and a connector 1162 configured to couple to the fitting 1186 (and each including one or more aspects of the present disclosure).

The fitting 1186 is configured for use in an irrigation system (e.g., irrigation system 101 of FIG. 1, etc.), for example, to couple desired pipes together (e.g., main line 103; other PVC pipes, polyethylene pipes, flexible pipes; etc.). The fitting 1186 includes end portions 1188 for use in coupling the fitting 1186 to the desired pipes, and a connecting portion 1190 for use in coupling the fitting 1186 to the connector 1162. While the illustrated fitting defines a generally T shape (e.g., defines a T-fitting, etc.), it should be appreciated that other fittings may be used with the connector 1162 in other embodiments (e.g., elbow fittings, Y-fittings, etc.). In addition, the connector 1162 is again illustrated as an elbow (or ninety-degree), funny pipe insert connector, but may include any other desired connector within the scope of the present disclosure. As such, the illustrated connector 1162 includes an inlet portion 1164 for use in coupling the connector 1162 to the fitting 1186 (e.g., for positioning within a channel 1114 of the connecting portion 1190 of the fitting 1186, etc.), and a barbed portion 1176 for use in coupling the connector 1162 to a pipe (e.g., a flexible tubing, a funny pipe, etc.).

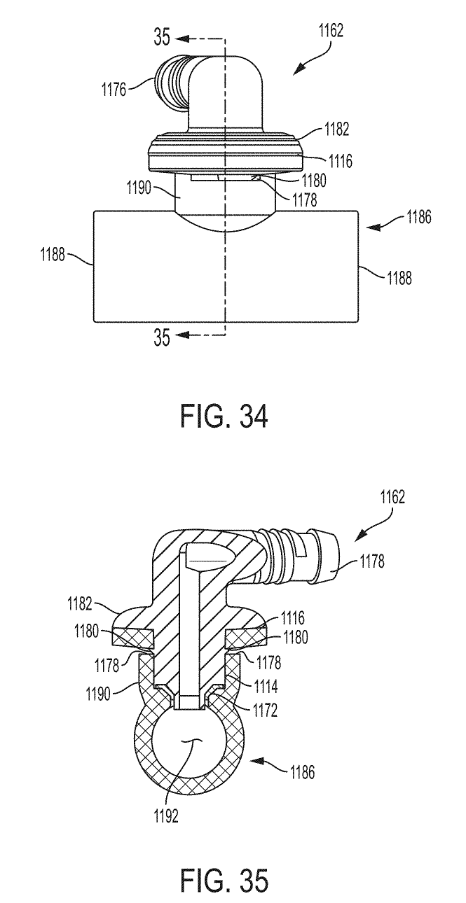

The connector 1162 and the fitting 1186 are configured for making a quick-connect coupling therebetween (e.g., without using, or as an alternative to using, conventional threads, etc.), when the inlet portion 1164 of the connector 1162 is positioned within the channel 1114 of the connecting portion 1190 of the fitting 1186 (FIGS. 34 and 35) (e.g., the fitting 1186 and the connector 1162 include a quick-connect coupling, etc.). To facilitate the quick-connect coupling, the fitting 1186 includes/defines openings 1178 (also referred to as quick-connect openings) positioned generally around the connecting portion 1190 of the fitting 1186. And, the connector 1162 includes tabs 1180 (e.g., flaps, protrusions, etc.) (also referred to as quick-connect protrusions) extending around the inlet portion 1164 and configured to generally snap-fit within corresponding ones of the openings 1178. The tabs 1180 are generally resilient in nature (e.g., are formed from resiliently deformable plastic, rubber, etc.) and extend (e.g., protrude, expand, deform, move, fold, etc.) into the openings 1178 when the connector 1162 is positioned on the fitting 1186 with the inlet portion 1164 within the fitting channel 1114 (FIGS. 34 and 35), to help secure the connector 1162 on the fitting 1186. In particular, the tabs 1180 may fold or deform generally against the inlet portion 1164 when positioned within the channel 1114, and then move back (away from the inlet portion 1164) when in alignment with the openings 1178. A rim 1182 of the connector 1162 is then also positioned generally adjacent (e.g., close to, in contact with, etc.) a surface 1116 of the connecting portion 1190 of the fitting 1186. The connector 1162 can then be removed from the fitting 1186, as desired, by manipulating the tabs 1180 out of the openings 1178.

The connector 1162 also includes a seal 1172 (e.g., a gasket, a rubber grommet, a plastic grommet, an O-ring, etc.) disposed around the inlet portion 1164 generally below the tabs 1180. In particular, the seal 1172 is located toward a tip of the inlet portion 1164 and is seated about a lip portion of the inlet portion 1164 (where the inlet portion 1164 generally narrows in diameter). When the inlet portion 1164 of the connector 1162 is positioned within the channel 1114 of the connecting portion 1190 of the fitting 1186, and the tabs 1180 are received within the openings 1178, the seal 1172 moves into position against an inner portion of the channel 1114 (and against an inner perimeter of the connecting portion 1190) of the fitting 1186 (generally where a diameter of the channel 1114 narrows, for example, at an inlet to a channel 1192 defined between end portions 1188 of the connector 1162) (FIG. 35). In this position, the seal 1172 further helps facilitate sealing the connector 1162 with, against, etc. the fitting 1186.

As such, when the connector 1162 is coupled to the fitting 1186, and the fitting 1186 is installed to desired pipes (e.g., installed within the main line 103 in the system 101 of FIG. 1, etc.), fluid in the pipe(s) can flow through the fitting 1186 and to the connector 1162 (via the channel 1114). A channel (FIG. 35) extends through the connector 1162, from the inlet portion 1164 to the barbed portion 1176 to accommodate fluid flow through the connector 1162. As such, from the connector 1162, the fluid can then be distributed as desired (e.g., to another pipe coupled to the barbed portion 1176 of the connector 1162, etc.).

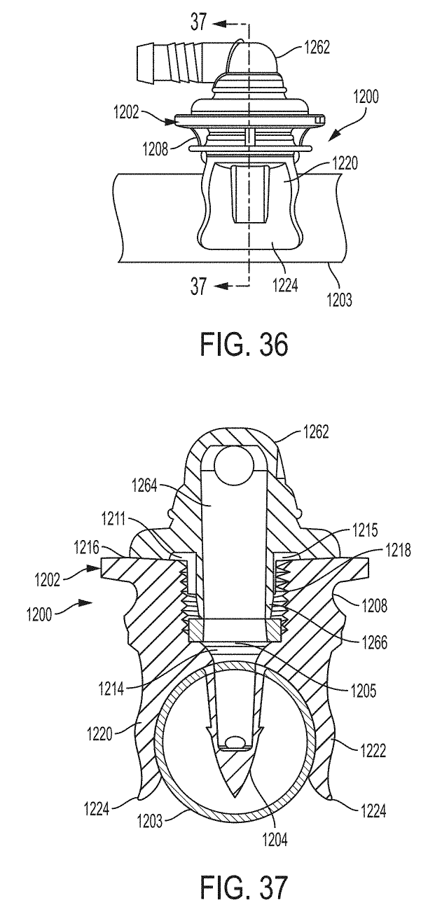

FIGS. 36-40 illustrate another exemplary embodiment of a fitting 1200 including one or more aspects of the present disclosure. The fitting 1200 is similar to the fittings 100, 200, 300 previously described and illustrated in FIGS. 1-10, FIGS. 11-14, and FIGS. 15-17, respectively. As such, the prior descriptions of the fittings 100, 200, 300 herein also generally apply to corresponding parts of the fitting 100, 200, 300 also included in this embodiment. In addition, it should be appreciated that the fitting 1200 of this embodiment may similarly be used in irrigation systems or otherwise, in similar fashion to that described for the fittings 100, 200, 300.

With that said, the fitting 1200 generally includes a saddle 1202 and a tap 1204 extending generally downwardly from the saddle 1202. The saddle 1202 and the tap 1204 of the illustrated fitting 1200 are formed as a single structure. And, the fitting 1200 can be press-fit (e.g., manually by users, etc.) onto a pipe to establish fluid connection, without threading or rotating the fitting 1200 (or any portion thereof, such as the tap 1204 relative to the saddle 1202) in order to install the fitting 1200 to the pipe 1203.

The saddle 1202 of the fitting 1200 includes a body 1208. The body 1208 is generally short and tubular in shape. And, a channel 1214 is defined by both the body 1208 and the tap 1204 to provide fluid communication through the fitting 1200. An upper end portion of the channel 1214, located toward an upper surface 1216 of the body 1208, includes optional threads 1218 to couple one or more other devices to the fitting 1200, for example, via a connector, etc., to establish the fluid communication between the fitting 1200 and the one or more other devices. However, other embodiments may not include threads in the channel. In addition, the upper surface 1216 of the body 1208 is also broad and substantially flat, to help facilitate manually pushing the fitting 1200 (via the upper surface 1216) into connection with the pipe 1203.

The body 1208 includes first and second arms 1220, 1222 extending generally away from the body 1208, which operate to support the fitting 1200 on the pipe 1203, for example, when inserting the tap 1204 into the pipe 1203. The arms 1220, 1222 are each generally arcuate in shape, and are each coupled to the body 1208 so that the arms 1220, 1222 can slightly move, flex, etc. relative to the body 1208 when positioning the pipe 1203 between the arms 1220, 1222. The arms 1220, 1222 operate to support the pipe 1203, when installing the fitting 1200 to the pipe 1203, and help maintain a rounded shape of the pipe 1203 when inserting the tap 1204 into the pipe 1203 (e.g., to help inhibit the pipe 1203 from flattening out when inserting the tap 1204, etc.). And, when the fitting 1200 is installed to the pipe 1203, the arms 1220, 1222 help support the fitting 1200 against rotation or other movement relative to the pipe 1203, for example, when coupling a connector to the fitting 1200, etc.

The arms 1220, 1222 each include a flared portion 1224 at an end of the arms 1220, 1222 opposite the body 1208. The flared portions 1224 are adapted to extend away from the sides of the pipe 1203 to facilitate insertion of the tap 1204 at least partly into the pipe 1203. The flared portions 1224 of the arms 1220, 1222 may reduce piercing of the sides of the pipe 1203 by the ends of the arms 1220, 1222 while the pipe 1203 is deformed during insertion of the tap 1204. For example, insertion of the tap 1204 into the pipe 1203 may cause the sides of the pipe 1203 to push outwards due to the pressure of the tap 1204 against the top of the pipe 1203 as it is being inserted. To reduce potential piercing of the sides of the pipe 1203 by the ends of the arms 1220, 1222, the flared portions 1224 extend outwardly from the sides of the pipe 1203 to reduce any sharp edges cutting into the side of the pipe 1203 as it is deformed. As shown in FIG. 37, the flared portions 1224 have an arcuate interior edge to glide along the outside of the pipe 1203 as the arms 1220, 1222 of the saddle 1202 are coupled about the pipe 1203. As should be apparent, other embodiments may have flared portions defining different shapes, different angles away from the pipe 1203, etc.

A distance between inner surfaces of the arms 1220, 1222 may correspond to an outer diameter of the pipe 1203 to facilitate coupling the arms 1220, 1222 about the pipe 1203. A distance between the flared portion ends of the arms 1220, 1222 may be greater than an outer diameter of the pipe 1203. Accordingly, the inner surfaces of arms 1220, 1222 may provide coupling contact with the outer surface of the pipe 1203 while the flared portion 1222 at the ends of arms 1220, 1222 extend outwards from the pipe 1203.

Also in the illustrated embodiment, and as shown in FIGS. 36 and 37, a connector 1262 is provided for coupling to the fitting 1200. In particular in this embodiment, the fitting 1200 and the connector 1262 are configured for making a coupling therebetween when an inlet portion 1264 of the connector 1262 is positioned within an upper end portion of the channel 1214 of the fitting 1200. While the connector 1262 is shown as a funny-pipe elbow connector, it should be appreciated that such coupling may be used between the fitting 1200 and any desired style of connector within the scope of the present disclosure.

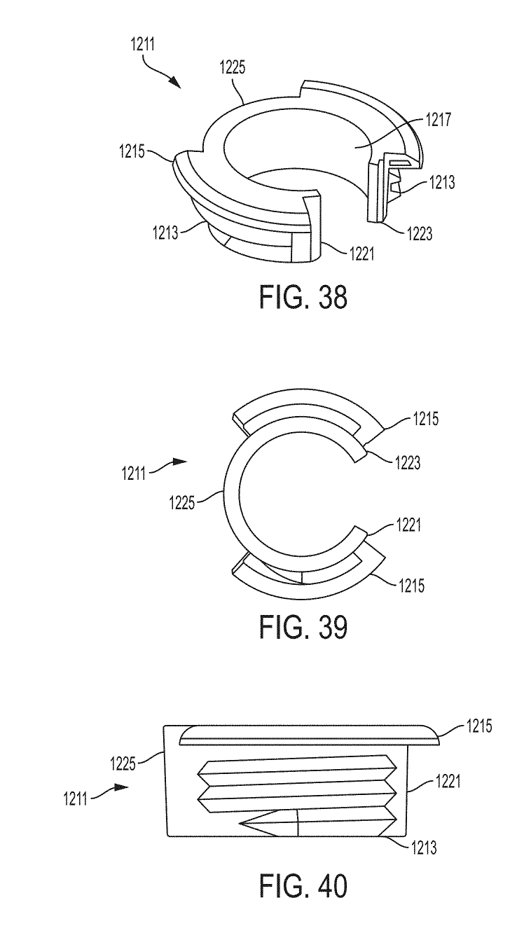

With additional reference to FIGS. 38-40, to facilitate the coupling between the fitting 1200 and the connector 1262, a snap clip 1211 is included between a protrusion/neck 1266 of the connector 1262 and the threads 1218 of the channel 1214 of the saddle 1202. The snap clip 1211 includes threads (or threaded surfaces 1213) on an exterior surface for coupling to the threads 1218 of the channel 1214 of the saddle 1202. The snap clip 1211 also includes a non-threaded (e.g., smooth, etc.) inner surface 1217 for proving a friction fit with the protrusion 1266 of the connector 1262. Accordingly, the snap clip 1211 may be inserted into the channel 1214 of the saddle 1202 to then provide a coupling between the unthreaded protrusion 1266 of the connector 1262 and the saddle 1202 (even though the channel 1214 of the saddle 1202 includes the threads 1218).

The snap clip 1211 also includes a stop surface lip 1215 that contacts the upper surface 1216 of the saddle 1204 at an end of the channel 1214. The stop surface lip 1215 facilitates a fixed depth of insertion of the snap clip 1211. For example, a user may compress the snap clip 1211 (e.g., squeeze the threaded surfaces 1213 of the snap clip 1211 together, etc.) to insert the snap clip 1211 into the channel 1214 of the saddle 1204. Compressing the snap clip 1211 in this manner may cause the diameter of the threaded surface 1213 of the snap clip 1211 to generally reduce, such that the threaded surface 1213 can be inserted past the threads 1218 of the channel 1214. In so doing, the user can insert the snap clip 1211 into the channel 1214 until the stop surface lip 1215 contacts the upper surface 1216 of the saddle 1202, and then release the snap clip 1211 such that it expands and the threaded surface 1213 of the snap clip 1211 couples with the threads 1218 of the channel 1214. The stop surface lip 1203 can thus control how far the snap clip 1211 is inserted into the channel 1214.

Normally, the smooth surface of the connector protrusion 1266 would not provide a solid coupling with the threads 1218 of channel 1214. However, snap clip 1211 provides an interface to create a secure coupling between the connector 1262 and the saddle 1204 due to the exterior threaded surface 1213 of the snap clip 1211 engaging the threads 1218 of the channel 1214 and the interior smooth surface 1217 of the snap clip 1211 accommodating the smooth surface of the connector protrusion 1266. Specifically, the outer surface of the snap clip 1211 corresponds to an inner diameter of the threaded channel 1214 of saddle 1202, thereby essentially proving a threaded coupling between the snap clip 1211 and the threaded channel 1214. In addition, an inner diameter of snap clip 1211 corresponds to an outer diameter of protrusion 1266 of connector 1262 to provide a friction fit with the protrusion 1266. Accordingly, the snap clip 1211 provides a mating interface between the connector 1262 and the saddle 1202. It should be apparent that the snap clip 1211 can be used in any embodiment herein, as appropriate or desired, to couple a smooth connector protrusion with a threaded fitting channel, and is not limited to use with the specific connector 1262 and saddle 1202 illustrated in FIGS. 36 and 37.

In addition in this embodiment, a seal 1219 is coupled between the connector protrusion 1266 and the channel 1214. The seal 1219 may be any suitable gasket, etc. capable of inhibiting water flow. As shown in FIG. 37, the seal 1219 is placed generally in the bottom of the channel 1214. In other embodiments, the connector 1262 and/or the saddle 1202 may include seal(s) in other locations, such as near the snap clip 1211, at the upper surface 1216 of the saddle 1202, etc.

With continued reference to FIGS. 38-40, the snap clip 1211 includes first and second wall portions 1221, 1223. The wall portions 1221, 1223 are generally opposite one another. Each of the wall portions 1221, 1223 includes one of the outer threaded surfaces 1213, and each includes an inner smooth surface 1217. The snap clip 1211 also includes a bridge portion 1225 disposed generally between the wall portions 1221, 1223 and coupling the wall portions 1221, 1223 together. The bridge portion 1215 may have a same height as the wall portions 1221, 1223, but generally does not include a threaded surface 1213 (but this is not required in all embodiments). With that said, it should be appreciated that the snap clip 1211 (and its associated parts) can be made of any suitable generally flexible material, including, for example, plastic, etc. In addition, the bridge portion 1225 and wall portions 1221, 1223 may be integral in various embodiments.

The bridge portion 1225 and wall portions 1221, 1223 of the snap clip 1211 define an arc having an inner diameter generally corresponding to the protrusion 1266 of the connector 1262 for creating a friction fit with the protrusion 1266. And, an outer diameter of the bridge member 1215 and the wall portions 1221, 1223 corresponds to the threaded channel 1214 of the saddle 1202 for generally creating a threaded connection with the channel 1214 of the saddle 1202 to facilitate coupling between the connector 1262 and the saddle 1202. The threaded surfaces 1213 of the snap clip 1211 may include any suitable threads capable of coupling with the threaded channel 1214 of the saddle 1202. For example, the threads may be half inch external male threads, etc. Although FIG. 40 illustrates three threads as part of the threaded surfaces 1213 on the exterior of the wall portions 1221, 1223, any suitable number of threads may be used.

The bridge portion 1225 (and optionally the wall portions 1221, 1223) may be flexible to allow the compression of the bridge portion 1225 (and optionally the wall portions 1221, 1223), as described above, such that the wall portions 1221, 1223 may be compressed towards one another. As also described above, this may facilitate insertion of the snap clip 1211 into the threaded channel 1214 of the saddle 1202 without rotation of the snap clip 1211, as the snap clip 1211 is instead compressed enough that the threaded surfaces 1213 of the snap clip 1211 can clear the threads 1218 of the channel 1214 of the saddle 1202. Once the snap clip 1211 is inserted into the channel 1214, the snap clip 1211 may be released such that the wall portions 1221, 1223 expand away from one another to contact the threads 1218 of the channel 1214 to create a generally threaded coupling between the snap clip 1211 and the saddle 1202. Accordingly, the snap clip 1211 may allow for easy insertion of the snap clip 1211 into the channel 1214 of the saddle 1202 (or other fittings) without the need to rotate the snap clip 1211 to screw the snap clip 1211 into the channel 1214. In the illustrated embodiment, the bridge portion 1225 and the wall portions 1221, 1223 of the snap clip 1211 define a substantially circular perimeter with an opening at one end (generally across from the bridge portion 1225). The opening provide space to facilitate the compression of the wall portions 1221, 1223, for easier insertion of the snap clip 1211 into the channel 1214 of the saddle 1202.

As described above, the snap clip 1211 includes the stop surface lip 1215. The stop surface lip 1215 extends away from an upper side of the wall portions 1221, 1223. The stop surface lip 1215 may be perpendicular to the wall portions 1221, 1223, or it may be oriented otherwise in other embodiments. The stop surface lip 1215, then, provides a stop surface for contacting the end of the saddle 1202 to facilitate a predetermined depth of insertion of the snap clip 1211 into the channel 1214 of the saddle 1202.

According to another exemplary embodiment of the present disclosure, a method of using a snap clip (e.g., snap clip 1211, etc.) to couple a connector to a fitting in an irrigation system is disclosed. The method includes inserting the snap clip into a threaded opening of the fitting to create a threaded coupling of the snap clip to the opening of the fitting, and inserting a protrusion of the connector into the snap clip to create a friction fit between the protrusion of the connector and the inner surface of the snap clip. This allows a user to quickly couple the connector to the fitting, even if the connector does not include a threaded protrusion corresponding to a threaded opening of the fitting. Accordingly, the method allows for greater interchanging of connectors and fittings. It should be apparent that the method can be used with any suitable connectors and fittings described herein. Alternatively, methods may include positioning the snap clip over inlet portions of connectors (where the snap clip may fit over a barbed inlet portion and secure thereto generally below the barb, etc.).

In connection therewith, inserting the snap clip may include compressing the snap clip such that an outer diameter of the external threaded surface of the snap clip is less than an inner diameter of the threaded opening of the fitting to facilitate insertion of the snap clip into the opening of the fitting without rotation of the snap clip, and releasing the snap clip such that the external threaded surface expands to contact the threaded opening of the fitting to create the threaded coupling of the snap clip to the opening of the fitting. Inserting the snap clip may include inserting the snap clip into the opening of the fitting until the stop surface lip contacts an end of the opening of the fitting, thereby facilitating insertion of the snap clip into the opening of the fitting at a fixed depth. Accordingly, a user can squeeze the snap clip together to quickly insert the snap clip into the threaded opening until the stop surface contacts the fitting, to facilitate proper insertion depth of the snap clip. The user can then release the quick snap clip to create the threaded coupling between the snap clip and the fitting opening. Depending on the orientation of the snap clip, the user may need to make slight adjustments by moving the snap clip upwards or downwards and/or rotating the snap clip to create a more secure coupling. The user can then insert the connector protrusion into the snap clip to create a friction fit and secure coupling between the connector and the fitting.

The method may also include inserting a seal into the opening of the fitting to create a seal between the opening of the fitting and the protrusion of the connector. The seal may be a gasket inserted at a bottom of the fitting opening, adjacent the top surface of the fitting in contact with the connector, etc.

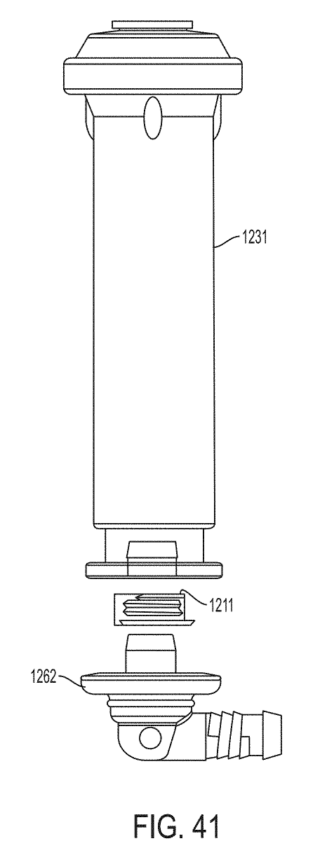

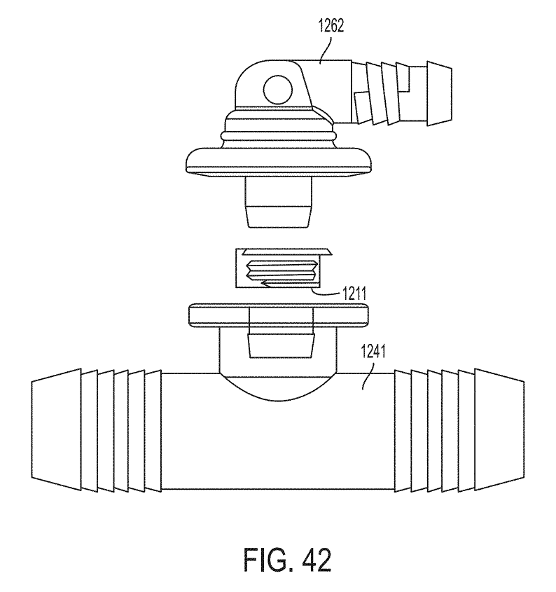

FIGS. 41 and 42 illustrate additional exemplary embodiments in which the snap clip 1211 is used to provide couplings between an elbow connector 1262 and two different fittings. In particular, FIG. 41 illustrates use of the snap clip 1211 to connect elbow connector 1262 to a sprinkler head fitting 1231. And, FIG. 42 illustrates use of the snap clip 1211 to connect elbow connector 1262 to a T-fitting 1241 (which may then be used to combine two sections of irrigation pipe, etc.). With that said, it should be appreciated that the snap clip 1211 operates to couple the elbow connector 1262 to each of the sprinkler head fitting 1231 and the T-fitting 1241 in the same manner described above. It should also be apparent that the snap clip 1211 can be used to couple any suitable connectors and irrigation system fittings, including the connectors and irrigation system fittings described herein.

Although FIG. 41 illustrates the snap clip 1211 as separate from the elbow connector 1262 and the sprinkler head fitting 1231, in other embodiments the snap clip 1211 may be coupled to, integral with, etc. a connector and/or fitting prior to coupling the connector to the fitting. For example, the snap clip 1211 could be integral with an end of the sprinkler head fitting 1231 (e.g., within a bottom opening thereof, as viewed in FIG. 41; etc.) to allow for ease of direct connection between the sprinkler head fitting 1231 and the elbow connector 1262 by inserting the integral snap clip portion of the sprinkler head fitting 1231 onto elbow connector 1262. Alternatively, the snap clip 1211 could be integral with an upper inlet end portion of the elbow connector 1262 (as viewed in FIG. 41) to allow for ease of direct connection between the sprinkler head fitting 1231 and the elbow connector 1262 by inserting the inlet end portion (and the integral snap clip portion) of the elbow connector 1262 into the sprinkler head fitting 1231. Similar to above, it should be apparent that the snap clip 1211 could be integral with any suitable connectors and irrigation system fittings, including the connectors and irrigation system fittings described herein (e.g., sprinkler heads, drains, valves, etc.).

In some embodiments, as mentioned above, the snap clip 1211 could be coupled to, integral with, etc. a connector and/or fitting prior to coupling the connector and the fitting. For example, the snap clip 1211 may not be integral with a fitting or connector, but could be coupled to the fitting or connector (e.g., via a snap fit, via a ledge of a barbed-style inlet portion, via an inlet opening, etc.) prior to coupling the connector to the fitting. This may provide an ease of use for direct connection between the fitting and the connector 1262 by inserting the coupled snap clip of the connector and/or fitting into the other of the connector and/or fitting.

The snap clip 1211 may couple to the elbow connector 1262 (or any other suitable connector) via a ledge of the elbow connector 1262. For example, the inlet portion of the elbow connector 1262 of FIG. 41 (i.e., the portion configured to couple to the sprinkler head fitting 1231) may include a ledge protrusion at the line (illustrated in FIG. 41) where the elbow connector begins to taper to receive the snap clip 1211. This ledge may have any suitable overhang, etc. to provide a catch, snap fit, etc. to retain the snap clip 1211 after the snap clip 1211 is coupled to the elbow connector 1262.

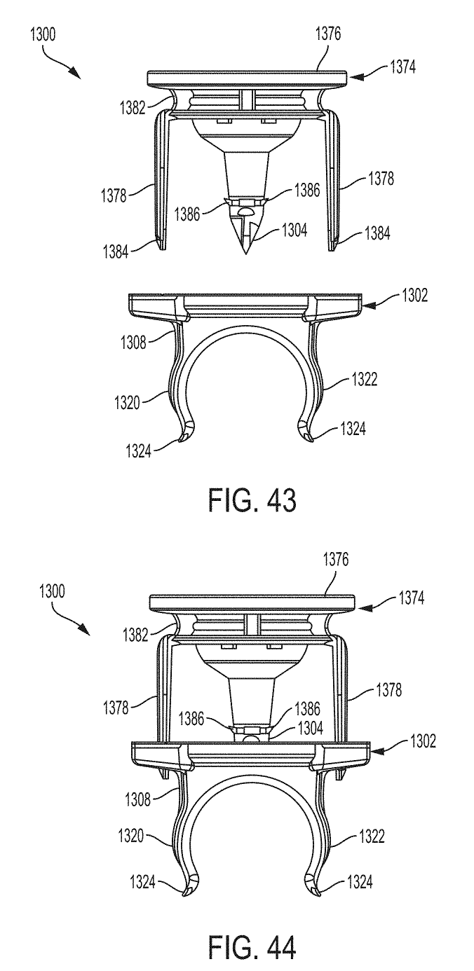

FIGS. 43-46 illustrate another exemplary embodiment of a fitting 1300 including one or more aspects of the present disclosure. The fitting 1300 is similar to the fittings 100, 200, 300 previously described and illustrated in FIGS. 1-10, FIGS. 11-14, and FIGS. 15-17, respectively. As such, the prior descriptions of the fittings 100, 200, 300 herein also generally apply to corresponding parts of the fitting 100, 200, 300 also included in this embodiment. In addition, it should be appreciated that the fitting 1300 of this embodiment may similarly be used in irrigation systems or otherwise, in similar fashion to that described for the fittings 100, 200, 300.

As shown in FIGS. 43 and 44, the fitting 1300 generally includes a saddle 1302 and a tap member 1374 having a tap 1304. In FIG. 43, the tap member 1374 is illustrated prior to coupling with the saddle 1302. And, in FIG. 44, the tap member 1374 is illustrated generally coupled to the saddle 1302 (e.g., in a preliminary configuration, etc.). Once coupled, as shown in FIG. 44, the saddle 1302 and the tap member 1374 of the illustrated fitting 1300 may be considered as a single structure (although the tap member 1374 may still be moveable relative to the saddle 1302). And, from this coupled configuration, the fitting 1300 can be press-fit (e.g., manually by users, etc.) onto a pipe (e.g., pipe 1303, etc.) to establish fluid connection between the fitting 1300 and the pipe, without threading or rotating the fitting 1300 (or any portion thereof, such as the tap 1304, etc. relative to the saddle 1302) in order to install the fitting 1300 to the pipe.

As shown, the saddle 1302 of the fitting 1300 includes a body 1308. The body 1308 is generally short and tubular in shape. And, a channel 1314 is defined by the tap 1304 and the tap member 1374 (see, FIG. 46) to provide fluid communication through the fitting 1300. An upper end portion of the channel 1314, located toward an upper surface 1376 of the tap member 1374, includes threads 1318 to couple one or more other devices to the fitting 1300, for example, via a connector, etc., to establish the fluid communication between the fitting 1300 and the one or more other devices. However, other embodiments may not include such threads in the channel 1314. In addition, the upper surface 1376 of the tap member 1374 is also broad and substantially flat, to help facilitate manually pushing the fitting 1300 (via the upper surface 1376) into connection with a pipe.

The body 1308 includes first and second arms 1320, 1322 extending generally away from the body 1308, which operate to support the fitting 1300 on a pipe, for example, when inserting the tap 1304 into the pipe. The arms 1320, 1322 are each generally arcuate in shape, and are each coupled to the body 1308 so that the arms 1320, 1322 can slightly move, flex, etc. relative to the body 1308 when positioning a pipe between the arms 1320, 1322. The arms 1320, 1322 operate to support a pipe, when installing the fitting 1300 to the pipe, and help maintain a rounded shape of the pipe when inserting the tap 1304 into the pipe (e.g., to help inhibit the pipe from flattening out when inserting the tap 1304, etc.). And, when the fitting 1300 is installed to a pipe, the arms 1320, 1322 help support the fitting 1300 against rotation or other movement relative to the pipe, for example, when coupling a connector to the fitting 1300, etc.

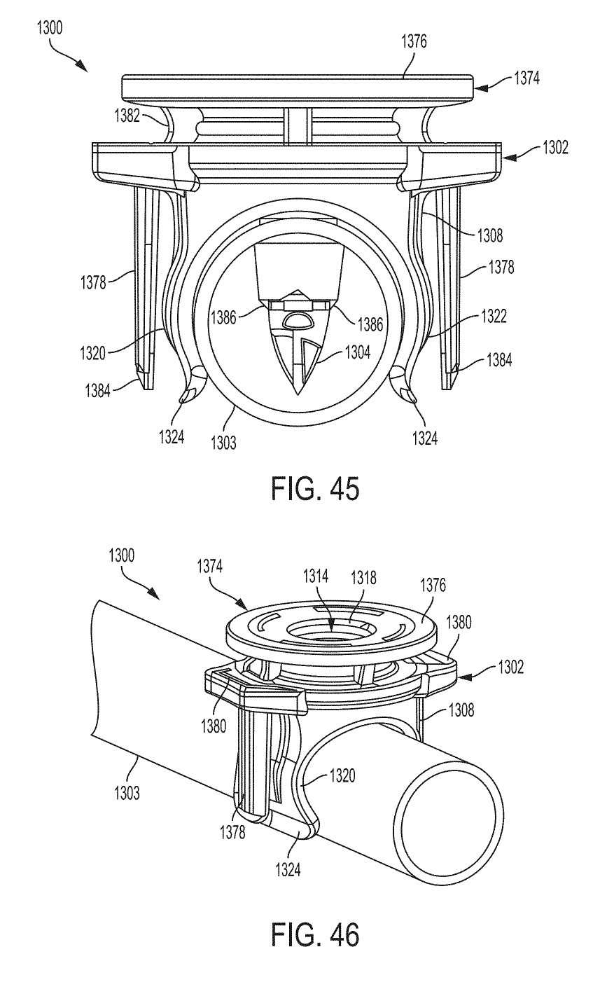

The arms 1320, 1322 each include a flared portion 1324 at an end of the arms 1320, 1322 opposite the body 1308. The flared portions 1324 are adapted to extend away from the sides of the pipe to facilitate insertion of the tap 1304 at least partly into the pipe. The flared portions 1324 of the arms 1320, 1322 may reduce piercing of the sides of the pipe by the ends of the arms 1320, 1322 while the pipe is deformed during insertion of the tap 1304. For example, insertion of the tap 1304 into the pipe may cause the sides of the pipe to push outward due to the pressure of the tap 1304 against the top of the pipe as it is being inserted. To reduce potential piercing of the sides of the pipe by the ends of the arms 1320, 1322, the flared portions extend outwardly from the sides of the pipe to reduce any sharp edges cutting into the side of the pipe as it is deformed. As shown in FIG. 45, for example, the flared portions 1322 have an arcuate interior edge to glide along the outside of pipe 1303 as the arms 1320, 1322 of the saddle 1302 are coupled about the pipe 1303. As should be apparent, other embodiments may have flared portions defining different shapes, different angles extending away from pipes, etc.

With additional reference to FIGS. 45 and 46, a distance between inner surfaces of the arms 1320, 1322 of the body 1308 may correspond to an outer diameter of the pipe 1303 to facilitate coupling the arms 1320, 1322 about the pipe 1303. And, a distance between the flared portions 1324 of the arms 1320, 1322 may be greater than an outer diameter of the pipe 1303. Accordingly, the inner surfaces of arms 1320, 1322 may provide coupling contact with the outer surface of the pipe 1303 while the flared portion 1324 at the ends of each of the arms 1320, 1322 extend outwards from the pipe 1303.

Also in this embodiment, the tap member 1374 includes two support arms 1378. The support arms 1378 are configured to couple the tap member 1374 to the saddle 1302 (and to allow the tap member 1374 to move relative to the saddle 1302, when coupled thereto, as described herein). The saddle 1302 defines slots 1380 (or openings) in the body 1308 of the saddle 1302 for receiving the support arms 1378 of the tap member 1374 there through. For example, in the illustrated embodiment, the saddle 1302 includes slots 1380 at opposite sides of the body 1308 of the saddle 1302, and the support arms 1378 may extend through the slots 1380 to couple the tap member 1374 to the saddle 1302. Although the tap member 1374 includes two support arms 1378 in the illustrated embodiment, it should be apparent that in other embodiments tap members may include more or less support arms.

The two support arms 1378 of the tap member 1374 are adapted to allow the tap member 1374 to move towards the body 1308 of the saddle 1302 from a first position extended from the saddle 1302 (e.g., FIG. 44, etc.) to a second position adjacent the saddle 1302 (e.g., FIG. 45, etc.).

With that said, FIG. 44 illustrates the tap member 1374 in the first position extended from the saddle 1302. In this position, the tap 1304 may not contact the pipe 1303, which can allow an operator to couple the saddle 1302 to the pipe 1303 before piercing the pipe 1303 with the tap 1304. Coupling the saddle 1302 prior to piercing the pipe 1303 with the tap 1304 may reduce the amount of force needed to insert the tap 1304 into the pipe 1303, etc. to make it easier for the operator to couple the fitting 1300 to the pipe 1303.

FIG. 45 illustrates the tap member 1374 moved to the second position, in which the tap member 1374 is adjacent the saddle 1302. In FIG. 45, the tap 1304 has been inserted into the pipe 1303. Accordingly, the fitting 1300 may allow a user to first couple the saddle 1302 to the pipe 1303 and then afterwards, pierce the pipe 1303 with the tap 1304 by pressing the tap member 1374 downwards. The body 1308 of the saddle 1302 defines an opening through which the tap 1304 extends, thereby allowing the tap 1304 pass through the opening of the body 1308 to pierce the pipe 1303 as the tap member 1374 is pushed down towards the saddle 1302 (i.e., as the tap member 1374 moves relative to the saddle 1302 (with the support arms 1378 sliding in the slots 1380) from the first position of FIG. 44 to the second position of FIG. 45). Although FIG. 45 illustrates the tap member 1374 contacting the saddle 1302 in the second position, it should be apparent that in other embodiments the tap member 1374 may not come into contact with the saddle 1302 when moved to the second position. For example, a gap could remain between the tap member 1374 and the saddle 1302 after the tap 1304 has pierced the pipe 1303.

The tap member support arms 1378 and tap 1304 extend generally downward from a body portion 1382 of the tap member 1374. Each support arm 1378 may include a ledge 1384 at an end portion of the support arm 1378. The ledges 1384 may be configured to snap fit through the slots 1380 of the saddle 1302 when initially coupling the tap member 1374 to the saddle 1302, and then may be configured to inhibit removal of the support arms 1378 from the slots 1380 of the saddle 1302 once the support arms 1378 are inserted into the slots 1380, thereby maintaining coupling between the tap member 1374 and the saddle 1302. For example, the ledges 1382 may allow the end portions of the support arms 1378 to be inserted into the slots 1380 of the saddle 1302 in a first direction (or when slightly flexed in a certain direction), but then catch a bottom side of the slots 1380 of the saddle 1302 (when the support arms 1378 are in a relaxed position) to inhibit the support arms 1378 from being removed from the slots 1380 of the saddle 1302.

Then in this embodiment, when the tap 1304 of the tap member 1374 is inserted into the pipe 1303, tabs 1386 located along the tap 1304 are configured to move into the pierced pipe 1303 and help retain the tap member 1374 on the pipe 1303. For example, the tabs 1386 generally extend past a pierced portion of the pipe 1303 to help inhibit movement of the tap 1304 out of the pipe 1303 (see, e.g., FIG. 45).

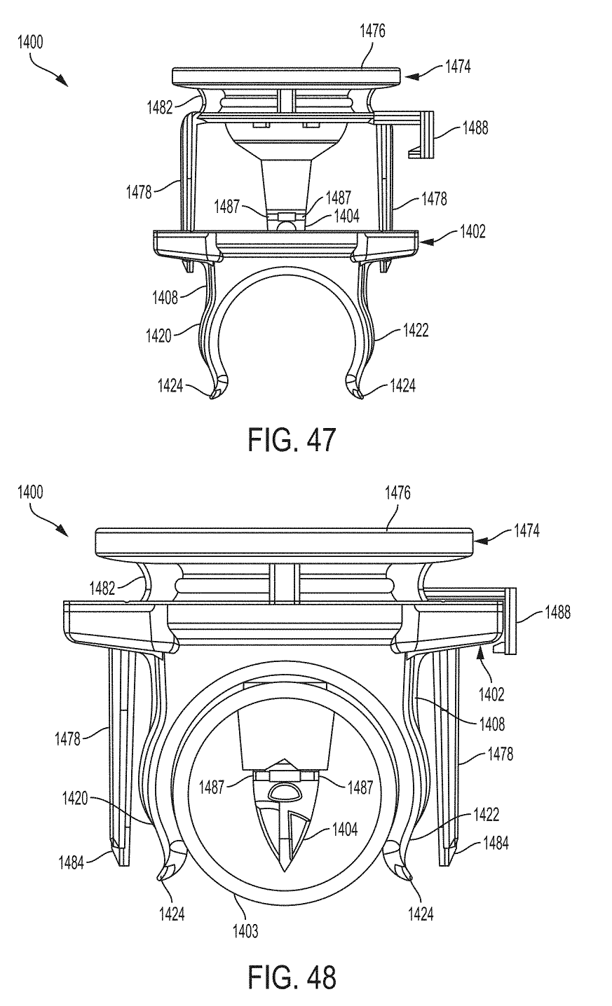

FIGS. 47 and 48 illustrate another exemplary embodiment of a fitting 1400 including one or more aspects of the present disclosure. The fitting 1400 is similar to the fittings 100, 200, 300, and 1300 previously described and illustrated in FIGS. 1-10, FIGS. 11-14, FIGS. 15-17, and FIGS. 43-48, respectively (and in particular fitting 1300). As such, the prior descriptions of the fittings 100, 200, 300, and 1300 herein also generally apply to corresponding parts of the fitting 100, 200, 300, and 1300 also included in this embodiment. In addition, it should be appreciated that the fitting 1400 of this embodiment may similarly be used in irrigation systems or otherwise, in similar fashion to that described for the fittings 100, 200, 300, and 1300.

As shown in FIGS. 47 and 48, the fitting 1400 generally includes a saddle 1402 and a tap member 1474 having a tap 1404. In FIG. 47, the tap member 1474 is illustrated generally coupled to the saddle 1402 (e.g., in a preliminary configuration, etc.). Once coupled, as shown in FIG. 47, the saddle 1402 and the tap member 1474 of the illustrated fitting 1400 may be considered as a single structure (although the tap member 1474 may still be moveable relative to the saddle 1402). And, from this coupled configuration, the fitting 1400 can be press-fit (e.g., manually by users, etc.) onto a pipe (e.g., pipe 1403, etc.) to establish fluid connection between the fitting 1400 and the pipe, without threading or rotating the fitting 1400 (or any portion thereof, such as the tap 1404, etc. relative to the saddle 1402) in order to install the fitting 1400 to the pipe.

As shown, the saddle 1402 of the fitting 1400 includes a body 1408. The body 1408 is generally short and tubular in shape. In addition, the upper surface 1476 of the tap member 1474 is also broad and substantially flat, to help facilitate manually pushing the fitting 1400 (via the upper surface 1476) into connection with a pipe.

The body 1408 includes first and second arms 1420, 1422 extending generally away from the body 1408, which operate to support the fitting 1400 on a pipe, for example, when inserting the tap 1404 into the pipe. The arms 1420, 1422 are each generally arcuate in shape, and are each coupled to the body 1408 so that the arms 1420, 1422 can slightly move, flex, etc. relative to the body 1408 when positioning a pipe between the arms 1420, 1422. The arms 1420, 1422 operate to support a pipe, when installing the fitting 1400 to the pipe, and help maintain a rounded shape of the pipe when inserting the tap 1404 into the pipe (e.g., to help inhibit the pipe from flattening out when inserting the tap 1404, etc.). And, when the fitting 1400 is installed to a pipe, the arms 1420, 1422 help support the fitting 1400 against rotation or other movement relative to the pipe, for example, when coupling a connector to the fitting 1400, etc.

In the illustrated embodiment, the arms 1420, 1422 each include a flared portion 1424 at an end of the arms 1420, 1422 opposite the body 1408. The flared portions 1424 are adapted to extend away from the sides of the pipe to facilitate insertion of the tap 1404 at least partly into the pipe. The flared portions 1424 of the arms 1420, 1422 may reduce piercing of the sides of the pipe by the ends of the arms 1420, 1422 while the pipe is deformed during insertion of the tap 1404. For example, insertion of the tap 1404 into pipe 1403 may cause the sides of the pipe 1403 to push outward due to the pressure of the tap 1404 against the top of the pipe 1403 as it is being inserted. To reduce potential piercing of the sides of the pipe 1403 by the ends of the arms 1420, 1422, the flared portions extend outwardly from the sides of the pipe 1403 to reduce any sharp edges cutting into the side of the pipe 1403 as it is deformed. As shown in FIG. 48, for example, the flared portions 1422 have an arcuate interior edge to glide along the outside of pipe 1403 as the arms 1420, 1422 of the saddle 1402 are coupled about the pipe 1403. As should be apparent, other embodiments may have flared portions defining different shapes, different angles extending away from pipes, etc.

Also in the illustrated embodiment, a distance between inner surfaces of the arms 1420, 1422 of the body 1408 may correspond to an outer diameter of the pipe 1403 to facilitate coupling the arms 1420, 1422 about the pipe 1403. And, a distance between the flared portions 1424 of the arms 1420, 1422 may be greater than an outer diameter of the pipe 1403. Accordingly, the inner surfaces of arms 1420, 1422 may provide coupling contact with the outer surface of the pipe 1403 while the flared portion 1424 at the ends of each of the arms 1420, 1422 extend outwards from the pipe 1403.

Further in this embodiment, the tap member 1474 includes two support arms 1478. The support arms 1478 are configured to couple the tap member 1474 to the saddle 1402 (and to allow the tap member 1474 to move relative to the saddle 1402, when coupled thereto, as described herein). Although the tap member 1474 includes two support arms 1478 in the illustrated embodiment, it should be apparent that in other embodiments tap members may include more or less support arms. The two support arms 1478 of the tap member 1474 are adapted to allow the tap member 1474 to move towards the body 1408 of the saddle 1402 from a first position extended from the saddle 1402 (e.g., FIG. 47, etc.) to a second position adjacent the saddle 1402 (e.g., FIG. 48, etc.).

With that said, FIG. 47 illustrates the tap member 1474 in the first position extended from the saddle 1402. In this position, the tap 1404 may not contact the pipe 1403, which can allow an operator to couple the saddle 1402 to the pipe 1403 before piercing the pipe 1403 with the tap 1404. Coupling the saddle 1402 prior to piercing the pipe 1403 with the tap 1404 may reduce the amount of force needed to insert the tap 1404 into the pipe 1403, etc. to make it easier for the operator to couple the fitting 1400 to the pipe 1403. Although this installation process is not required in all applications of the fitting 1400 (e.g., the tap may be used to pierce the pipe 1403 while coupling the saddle 1402 to the pipe 1403, etc.).

FIG. 48 illustrates the tap member 1474 moved to the second position, in which the tap member 1474 is adjacent the saddle 1402. In FIG. 48, the tap 1404 has been inserted into the pipe 1403. Accordingly, the fitting 1400 may allow a user to first couple the saddle 1402 to the pipe 1403 and then afterwards, pierce the pipe 1403 with the tap 1404 by pressing the tap member 1474 downwards. The body 1408 of the saddle 1402 defines an opening through which the tap 1404 extends, thereby allowing the tap 1404 to pass through the opening of the body 1408 to pierce the pipe 1403 as the tap member 1474 is pushed down towards the saddle 1402 (i.e., as the tap member 1474 moves relative to the saddle 1402 (with the support arms 1478 sliding in corresponding slots of the saddle 1402) from the first position of FIG. 47 to the second position of FIG. 48). Although FIG. 48 illustrates the tap member 1474 contacting the saddle 1402 in the second position, it should be apparent that in other embodiments the tap member 1474 may not come into contact with the saddle 1402 when moved to the second position. For example, a gap could remain between the tap member 1474 and the saddle 1402 after the tap 1404 has pierced the pipe 1403.

The tap member support arms 1478 and the tap 1404 extend generally downward from a body portion 1482 of the tap member 1474. Each support arm 1478 may include a ledge 1484 (FIG. 48) at an end portion of the support arm 1478. The ledges 1484 may be configured to snap fit through the slots of the saddle 1402 when initially coupling the tap member 1474 to the saddle 1402, and then may be configured to inhibit removal of the support arms 1478 from the slots of the saddle 1402 once the support arms 1478 are inserted into the slots, thereby maintaining coupling between the tap member 1474 and the saddle 1402. For example, the ledges 1482 may allow the end portions of the support arms 1478 to be inserted into the slots of the saddle 1402 in a first direction (or when slightly flexed in a certain direction), but then catch a bottom side of the slots of the saddle 1402 (when the support arms 1478 are in a relaxed position) to inhibit the support arms 1478 from being removed from the slots of the saddle 1402.

With continued reference to FIGS. 47 and 48, the tap member 1474 also includes a clasp 1488 adapted to couple the tap member 1474 to the saddle 1402. As shown in FIG. 47, the clasp 1488 extends from a portion of the support arm 1478. This allows the clasp 1488 to couple the tap member 1474 to the saddle 1402 when the tap member 1474 is moved to the second position adjacent the saddle 1402. For example, as shown in FIG. 48, the clasp 1488 can snap-fit, etc. around an outer portion of the saddle 1402 to couple the tap member 1474 to the saddle 1402. Although clasp 1488 is illustrated as extending from the support arm 1478 and coupling around a top outer portion of the saddle 1402 in FIG. 48, it should be apparent that other embodiments may include a clasp (or multiple clasps) extending from different portions of the tap member 1474 (e.g., not from the support arm 1478, or not from a support arm at all, etc.), a clasp (or multiple clasps) that couple to other portions of the saddle 1402 (e.g., other than a top outer portion of the saddle, etc.), a clasp (or multiple clasps) that couple to the saddle using other coupling engagements (e.g., other than a snap-fit, etc.), etc. In some embodiments, the tap member 1474 may include two or more clasps 1488, etc.

The clasp 1488 is adapted to inhibit movement of the tap 1404 of tap member 1474 out of the pipe 1403 after the tap 1404 pierces the pipe 1403. For example, if the saddle is coupled to the pipe 1403 via arms 1420 and 1422, the clasp 1488 may inhibit movement of the tap member 1474 relative to the saddle 1402 and out of the pipe 1403. Therefore, the clasp 1488 can inhibit the tap member 1474 from moving or pulling away from the pipe 1403 after tap 1404 pierces the pipe 1403.

Although FIGS. 47 and 48 illustrate a clasp 1488 extending from a portion of the support arm 1478 to snap-fit around an outer portion of the saddle 1402 (and to thereby hold the tap member 1474 in the second position), other embodiments may include a tab, etc. in place of clasp 1488 that does not extend around an outer portion of the saddle 1402 (but still operates to hold the tap member 1474 in the second position relative to the saddle 1402). For example, the support arm 1478 may include a tab, detent, protrusion, etc., configured to couple to an inner portion of the saddle 1402, a slot defined in the saddle 1402 that receives the support arm 1478, etc. The tab, detent, protrusion, etc., may contact a lower surface of the saddle 1402 (e.g., adjacent the slot, etc.) for retaining the tap member 1474 against the saddle 1402. In some embodiments, the tab, detent, protrusion, etc. may extend from a portion of the tap member 1478 other than a support arm 1478. In general, the tap member 1474 may include any desired structure configured to engage the saddle 1402 when the tap member 1474 is in the second position to help hold, retain, etc. the tap member 1474 in the second position, relative to the saddle 1402, for example, when the fitting 1400 is coupled to a pipe (and to thereby help inhibit fluid pressure from fluid in the pipe inadvertently moving the tap member 1474 out of the pipe during use, etc.).

Therefore, the tap 1404 may not require any tabs (e.g., tabs 1386 illustrated in FIGS. 43 and 44, etc.) to hold the tap 1404 in the pipe 1403 after the tap 1404 pierces the pipe 1403 (and still resist movement of the tap 1404 out of the pipe due to fluid pressure in the pipe, etc.). As shown in FIGS. 47 and 48, tap 1404 includes surfaces 1487 disposed along the tap 1404 (e.g., instead of tabs 1386 illustrated in FIGS. 43 and 44, etc.). The surfaces 1487 may provide reduced friction for piercing the pipe 1403, easier removal of the tap 1404 out of pipe 1403 when desired (e.g., by decoupling tap member 1474 and saddle 1402 using clasp 1488, etc.), a stronger seal at the interface of the tap 1404 and the pierced pipe wall (e.g., having less deformation due to no tabs present on the tap 1404, etc.).

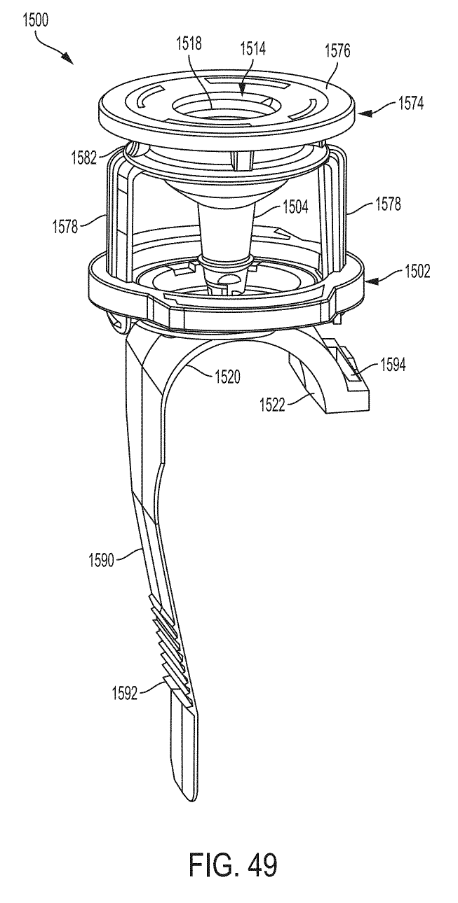

FIG. 49 illustrates another exemplary embodiment of a fitting 1500 including one or more aspects of the present disclosure. The fitting 1500 is similar to the fittings 100, 200, 300, 1300 and 1400 previously described and illustrated in FIGS. 1-10, FIGS. 11-14, FIGS. 15-17, FIGS. 43-48, and FIGS. 48-49, respectively (and in particular fitting 1300). As such, the prior descriptions of the fittings 100, 200, 300, 1300 and 1400 herein also generally apply to corresponding parts of the fitting 100, 200, 300, 1300 and 1400 also included in this embodiment. In addition, it should be appreciated that the fitting 1500 of this embodiment may similarly be used in irrigation systems or otherwise, in similar fashion to that described for the fittings 100, 200, 300, 1300 and 1400.

As shown in FIG. 49, the fitting 1500 generally includes a saddle 1502 and a tap member 1574 having a tap 1504. In FIG. 49, the tap member 1574 is illustrated generally coupled to the saddle 1502 (e.g., in a preliminary configuration, etc.). Once coupled, the saddle 1502 and the tap member 1574 of the illustrated fitting 1500 may be considered as a single structure (although the tap member 1574 may still be moveable relative to the saddle 1502). And, from this coupled configuration, the fitting 1500 can be press-fit (e.g., manually by users, etc.) onto a pipe to establish fluid connection between the fitting 1500 and the pipe, without threading or rotating the fitting 1500 (or any portion thereof, such as the tap 1504, etc. relative to the saddle 1502) in order to install the fitting 1500 to the pipe.

A channel 1514 is defined by the tap 1504 and the tap member 1574 to provide fluid communication through the fitting 1500. An upper end portion of the channel 1514, located toward an upper surface 1576 of the tap member 1574, includes threads 1518 to couple one or more other devices to the fitting 1500, for example, via a connector, etc., to establish the fluid communication between the fitting 1500 and the one or more other devices. However, other embodiments may not include such threads in the channel 1514. In addition, the upper surface 1576 of the tap member 1574 is also broad and substantially flat, to help facilitate manually pushing the fitting 1500 (via the upper surface 1576) into connection with a pipe.

The saddle 1502 includes first and second arms 1520, 1522, which operate to support the fitting 1500 on a pipe, for example, when inserting the tap 1504 into the pipe. Arm 1520 includes a strap 1590. Arm 1522 defines an opening 1594 adapted to receive the strap 1590. For example, strap 1590 may have a length sufficient to wrap around at least a portion of the pipe to couple with opening 1594 defined in arm 1522. Therefore, the strap 1590 is adapted to inhibit movement of the saddle 1502 away from the pipe when the saddle is coupled to the pipe.

In the illustrated embodiment, the strap 1590 associated with the arm 1520 includes one or more ledges 1592. The ledges 1592 are disposed on an outer portion of strap 1590 and are adapted to catch the opening 1594 defined in arm 1522 when the strap 1590 is inserted in the opening 1594. The multiple ledges 1592 can allow the strap 1590 to wrap around pipes of different sizes to still provide a secure fit to inhibit movement of the saddle 1502 away from the pipe (generally regardless of the size of the pipe). For example, a user may couple arms 1520, 1522 about a pipe, wrap the strap 1590 around the bottom of the pipe and insert an end of the strap 1590 into opening 1594, and then pull the strap 1590 through the opening 1594 until a secure fit is achieved around the pipe. The multiple ledges 1592 can allow the length of the strap 1590 to easily conform to the diameter, circumference, etc. of the pipe. As should be apparent, other embodiments may have more or less ledges 1592. In addition, and as in other embodiments herein, the strap 1590 may help support the fitting 1500 against rotation or other movement relative to the pipe, for example, when coupling a connector to the fitting 1500, etc.

Coupling the saddle 1502 to the pipe via strap 1590 may reduce piercing of the sides of the pipe by the arms 1520, 1522 while the pipe is deformed during insertion of the tap 1504. For example, insertion of the tap 1504 into the pipe may cause the sides of the pipe to push outward due to the pressure of the tap 1504 against the top of the pipe as it is being inserted. To reduce potential piercing of the sides of the pipe by arms 1520, 1522, the strap 1590 may provide substantially uniform pressure around the pipe as it is deformed (e.g., when the saddle 1502 is coupled to the pipe in advance of piercing the pipe, etc.).

Also in this embodiment, the tap member 1574 again includes two support arms 1578 extending from a body 1582 of the tap member 1574. The support arms 1578 are configured to couple the tap member 1574 to the saddle 1502 (and to allow the tap member 1574 to move relative to the saddle 1502, when coupled thereto, as described herein). Although the tap member 1574 includes two support arms 1578 in the illustrated embodiment, it should be apparent that in other embodiments tap members may include more or less support arms. The two support arms 1578 of the tap member 1574 are adapted to allow the tap member 1574 to move towards the saddle 1502 from a first position extended from the saddle 1502 to a second position adjacent the saddle 1502.

With that said, FIG. 49 illustrates the tap member 1574 in the first position extended from the saddle 1502. In this position, the tap 1504 may not contact the pipe, which can allow an operator to couple the saddle 1502 to the pipe 1503 before piercing the pipe with the tap 1504. Coupling the saddle 1502 prior to piercing the pipe with the tap 1504 may reduce the amount of force needed to insert the tap 1504 into the pipe, etc. to make it easier for the operator to couple the fitting 1500 to the pipe 1503. The fitting 1500, then, may allow a user to first couple the saddle 1502 to the pipe using strap 1590 (with the tap member 1574 in the first position, for example). Then afterwards, the user can pierce the pipe with the tap 1504 by pressing the tap member 1574 downwards (and moving the tap member 1574 to a second position). The saddle 1502 defines an opening through which the tap 1504 extends, thereby allowing the tap 1504 pass through the opening of the saddle 1502 to pierce the pipe as the tap member 1574 is pushed down towards the saddle 1502 (i.e., as the tap member 1574 moves relative to the saddle 1502 to the second position (with the support arms 1578 sliding in slots of the saddle 1502). Again, the strap 1590 may assist in inhibiting movement of saddle 1502 (e.g., away from the pipe, etc.) as the user presses the tap 1504 into the pipe to pierce the pipe.

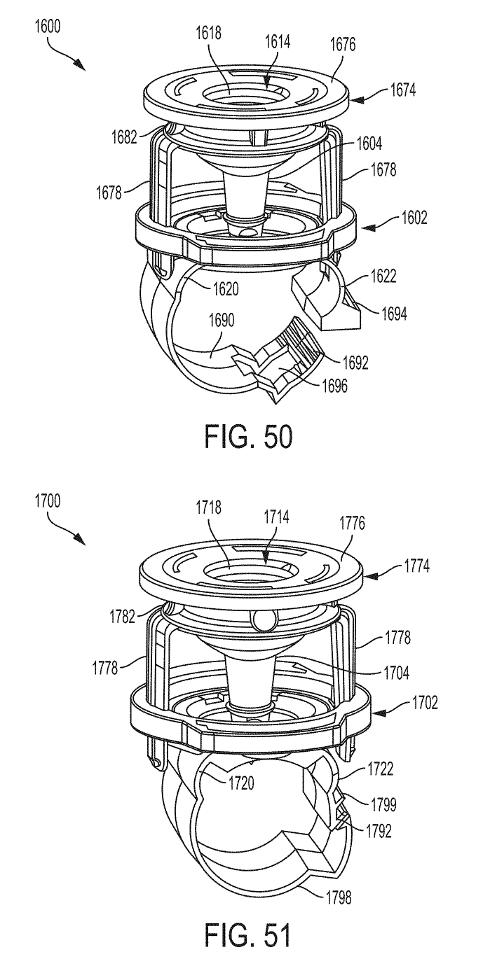

FIG. 50 illustrates another exemplary embodiment of a fitting 1600 including one or more aspects of the present disclosure. The fitting 1600 is similar to fitting 1500 illustrated in FIG. 49, but fitting 1600 includes a strap 1690 defining an opening 1696 in the strap 1690. Also, ledges 1692 are disposed on an inner portion of strap 1690.

In particular, as shown in FIG. 50, the fitting 1600 generally includes a saddle 1602 and a tap member 1674 having a tap 1604. In FIG. 50, the tap member 1674 is illustrated generally coupled to the saddle 1602, such that the saddle 1602 and the tap member 1674 of the illustrated fitting 1600 may be considered as a single structure (although the tap member 1674 may still be moveable relative to the saddle 1602). And, from this coupled configuration, the fitting 1600 can be press-fit (e.g., manually by users, etc.) onto a pipe to establish fluid connection between the fitting 1600 and the pipe, without threading or rotating the fitting 1600 (or any portion thereof, such as the tap 1604, etc. relative to the saddle 1602) in order to install the fitting 1600 to the pipe.

A channel 1614 is defined by the tap 1604 and the tap member 1674 to provide fluid communication through the fitting 1600. An upper end portion of the channel 1614, located toward an upper surface 1676 of the tap member 1674, includes threads 1618 to couple one or more other devices to the fitting 1600, for example, via a connector, etc., to establish the fluid communication between the fitting 1600 and the one or more other devices. However, other embodiments may not include such threads in the channel 1614. In addition, the upper surface 1676 of the tap member 1674 is also broad and substantially flat, to help facilitate manually pushing the fitting 1600 (via the upper surface 1676) into connection with a pipe.

The saddle 1602 includes first and second arms 1620, 1622, which operate to support the fitting 1600 on a pipe, for example, when inserting the tap 1604 into the pipe. Arm 1620 includes a strap 1690. Arm 1622 defines an opening 1694 adapted to receive the strap 1690. For example, strap 1690 may have a length sufficient to wrap around at least a portion of the pipe to couple with opening 1694 defined in arm 1622. Therefore, the strap 1690 is adapted to inhibit movement of the saddle 1602 away from the pipe when the saddle is coupled to the pipe.

As shown in FIG. 50, strap 1690 includes one or more ledges 1692. The ledges 1692 are disposed on an outer portion of strap 1690 and are adapted to catch the opening 1694 defined in arm 1622 when the strap 1690 is inserted in the opening 1694. The multiple ledges 1692 can allow the strap 1690 to wrap around pipes of different sizes to provide a secure fit to inhibit movement of the saddle 1602 away from the pipe (generally regardless of a size of the pipe). For example, a user may couple arms 1620, 1622 about a pipe, wrap the strap 1690 around the bottom of the pipe and insert an end of the strap 1690 into opening 1694, and then pull the strap 1690 through the opening 1694 until a secure fit is achieved around the pipe. The multiple ledges 1692 can allow the length of strap 1690 to easily conform to the diameter, circumference, etc. of the pipe. As should be apparent, other embodiments may have more or less ledges 1692. The strap 1690 may help support the fitting 1600 against rotation or other movement relative to the pipe, for example, when coupling a connector to the fitting 1600, etc.

In the illustrated embodiment, the strap 1690 has a generally arcuate shape. And, where the strap 1590 of FIG. 49 may be more flexible, strap 1690 of FIG. 50 may be more rigid to hold the generally arcuate shape (although strap 1690 may also bend, flex, etc. to be placed around a pipe when the saddle 1602 is coupled to the pipe).

The strap 1690 defines an opening 1696 in strap 1690. As shown in FIG. 50, the opening 1696 has a generally rectangular shape. However, it should be apparent that other embodiments may include openings 1696 having different shapes (e.g., circular, etc.). The opening 1696 is defined adjacent ledges 1692, although it should be apparent that other embodiments may include opening(s) defined in other locations along strap 1690. The opening 1696 may allow for additional connectors to pierce the pipe, establish fluid communication, etc. through strap 1690. Therefore, fitting 1690 could be coupled to a pipe initially using strap 1690, and then afterwards an operator could make another fluid connection with the pipe through opening 1696 without having to move strap 1690 and/or fitting 1600. Alternatively, the opening 1696 may be used to receive a protrusion at the opening 1694 to help secure the strap 1690 thereto.

Coupling the saddle 1602 to the pipe via strap 1690 may reduce piercing of the sides of the pipe by the arms 1620, 1622 while the pipe is deformed during insertion of the tap 1604. For example, insertion of the tap 1604 into the pipe may cause the sides of the pipe to push outward due to the pressure of the tap 1604 against the top of the pipe as it is being inserted. To reduce potential piercing of the sides of the pipe by arms 1620, 1622, the strap 1690 may provide substantially uniform pressure around the pipe as it is deformed (when the saddle 1602 is coupled to the pipe in advance of piercing the pipe).

Similar to embodiments described above, tap member 1674 includes two support arms 1678 extending from a body 1682 of the tap member 1674. The support arms 1678 are configured to couple the tap member 1674 to the saddle 1602 and to allow the tap member 1674 to move relative to the saddle 1602. For example, the fitting 1600 may allow a user to first couple the saddle 1602 to the pipe using strap 1690. Then afterwards, the user can pierce the pipe with the tap 1604 by pressing the tap member 1674 downwards. The saddle 1602 defines an opening through which the tap 1604 extends, thereby allowing the tap 1604 pass through the opening of the saddle 1602 to pierce the pipe as the tap member 1674 is pushed down towards the saddle 1602. The strap 1690 may assist in inhibiting movement of saddle 1602 (e.g., away from the pipe, etc.) as the user presses the tap 1604 into the pipe to pierce the pipe.

FIG. 51 illustrates another exemplary embodiment of a fitting 1700 including one or more aspects of the present disclosure. The fitting 1700 is similar to fittings 1500 and 1600 illustrated in FIGS. 49 and 50, but fitting 1700 includes a jaw portion 1798 instead of straps 1590 or 1690. Also, a single ledge 1792 is disposed at an inner end portion of jaw portion 1798.

As shown in FIG. 51, for example, the fitting 1700 generally includes a saddle 1702 and a tap member 1774 having a tap 1704. The tap member 1774 is illustrated generally coupled to the saddle 1702, such that the saddle 1702 and the tap member 1774 of the illustrated fitting 1700 may be considered as a single structure (although the tap member 1774 may still be moveable relative to the saddle 1702). And, from this coupled configuration, the fitting 1700 can be press-fit (e.g., manually by users, etc.) onto a pipe to establish fluid connection between the fitting 1700 and the pipe, without threading or rotating the fitting 1700 (or any portion thereof, such as the tap 1704, etc. relative to the saddle 1702) in order to install the fitting 1700 to the pipe.

A channel 1714 is defined by the tap 1704 and the tap member 1774 to provide fluid communication through the fitting 1700. An upper end portion of the channel 1714, located toward an upper surface 1776 of the tap member 1774, includes threads 1718 to couple one or more other devices to the fitting 1700, for example, via a connector, etc., to establish the fluid communication between the fitting 1700 and the one or more other devices. However, other embodiments may not include such threads in the channel 1714. In addition, the upper surface 1776 of the tap member 1774 is also broad and substantially flat, to help facilitate manually pushing the fitting 1700 (via the upper surface 1776) into connection with a pipe.

The saddle 1702 includes first and second arms 1720, 1722, which operate to support the fitting 1700 on a pipe, for example, when inserting the tap 1704 into the pipe. Arm 1720 includes the jaw portion 1798. Arm 1722 includes multiple catches 1799 adapted to receive the jaw portion 1798. For example, jaw portion 1798 may have a length sufficient to wrap around at least a portion of the pipe to couple with at least one of catches 1799 of arm 1722. Therefore, the jaw portion 1798 is adapted to inhibit movement of the saddle 1702 away from the pipe when the saddle 1702 is coupled to the pipe.

As shown in FIG. 51, jaw portion 1798 includes the one or more ledges 1792. The ledges 1792 are disposed on an inner end portion of jaw portion 1798 and are adapted to engage at least one of the catches 1799 of arm 1722 when the jaw portion 1798 is coupled to arm 1722. The multiple ledges 1792 can allow the jaw portion 1798 to wrap around pipes of different sizes to provide a secure fit to inhibit movement of the saddle 1702 away from the pipe. For example, a user may couple arms 1720, 1722 about a pipe, wrap the jaw portion 1798 around the bottom of the pipe and insert a ledge 1792 of the jaw portion 1798 onto a catch 1799 of arm 1722. The multiple ledges 1792 can allow the length of the jaw portion 1798 to easily conform to the diameter, circumference, etc. of the pipe, because a user can select the ledge 1792 that provides the most secure fit. As should be apparent, other embodiments may have more or less ledges 1792. The jaw portion 1798 may help support the fitting 1700 against rotation or other movement relative to the pipe, for example, when coupling a connector to the fitting 1700, etc.

In the illustrated embodiment, the jaw portion 1798 has a generally arcuate shape. Where the strap 1590 of FIG. 49 may be more flexible, jaw portion 1798 of FIG. 51 may be more rigid to hold the generally arcuate shape (although jaw portion 1798 may also bend, flex, etc. to be placed around a pipe when the saddle 1702 is coupled to the pipe).

Coupling the saddle 1702 to the pipe via jaw portion 1798 may reduce piercing of the sides of the pipe by the arms 1720, 1722 while the pipe is deformed during insertion of the tap 1704. For example, insertion of the tap 1704 into the pipe may cause the sides of the pipe to push outward due to the pressure of the tap 1704 against the top of the pipe as it is being inserted. To reduce potential piercing of the sides of the pipe by arms 1720, 1722, the jaw portion 1798 may provide substantially uniform pressure around the pipe as it is deformed (when the saddle 1702 is coupled to the pipe in advance of piercing the pipe).

Similar to embodiments described above, tap member 1774 includes two support arms 1778 extending from a body 1782 of the tap member 1774. The support arms 1778 are configured to couple the tap member 1774 to the saddle 1702 and to allow the tap member 1774 to move relative to the saddle 1702. For example, the fitting 1700 may allow a user to first couple the saddle 1702 to the pipe using jaw portion 1798. Then afterwards, the user can pierce the pipe with the tap 1704 by pressing the tap member 1774 downwards. The saddle 1702 defines an opening through which the tap 1704 extends, thereby allowing the tap 1704 to pass through the opening of the saddle 1702 to pierce the pipe as the tap member 1774 is pushed down towards the saddle 1702 (with fluid communication then established between the fitting 1700 and the pipe via the tap member 1774 and channel 1714). The jaw portion 1798 may assist in inhibiting movement of saddle 1702 (e.g., away from the pipe, etc.) as the user presses the tap 1704 into the pipe to pierce the pipe.

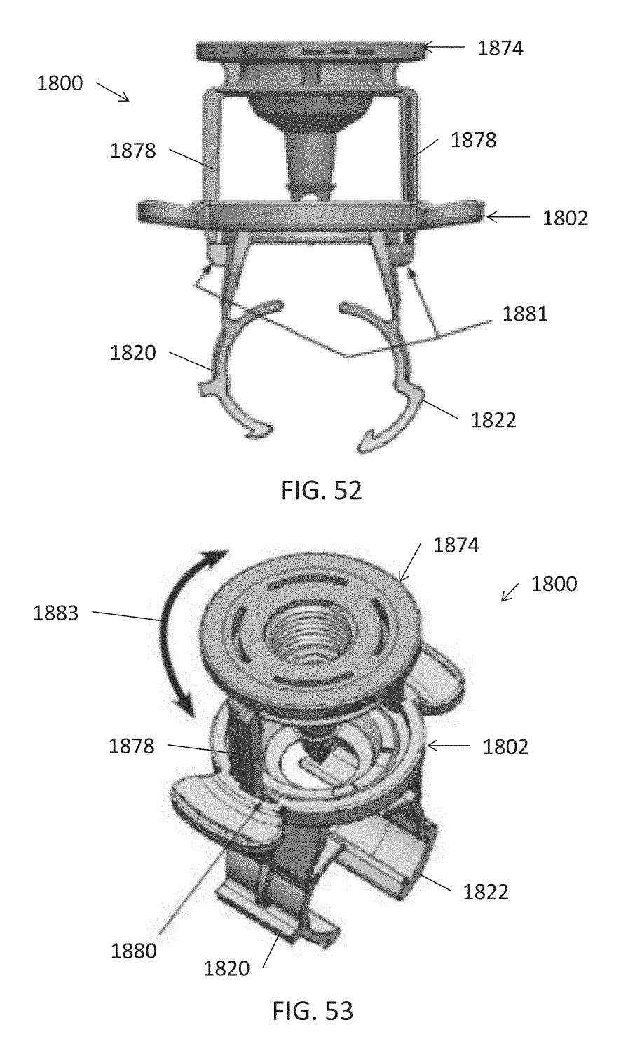

FIGS. 52 and 53 illustrate another exemplary embodiment of a fitting 1800 including one or more aspects of the present disclosure. The fitting 1800 is similar to fittings 1300, 1400, 1500, 1600 and 1700 illustrated in FIGS. 43-51. For example, the fitting 1800 generally includes a saddle 1802 and a tap member 1874 having a tap. The tap member 1874 is illustrated generally coupled to the saddle 1802, such that the tap member 1874 is moveable relative to the saddle 1802 (i.e., moveably coupled to the saddle 1802). And, from this coupled configuration, the fitting 1800 can be press-fit (e.g., manually by users, etc.) onto a pipe to establish fluid connection between the fitting 1800 and the pipe, without threading or rotating the fitting 1800 in order to install the fitting 1800 to the pipe (e.g., in order to cause the tap member 1874 to pierce the pipe, etc.).

Similar to other embodiments described herein, a channel is defined by the tap member 1874 to provide fluid communication through the fitting 1800, and an upper end portion of the channel is configured to couple one or more other devices to the fitting 1800, for example, via a connector, etc., to establish the fluid communication between the fitting 1800 and the one or more other devices. In addition, an upper surface of the tap member 1874 is also broad and substantially flat, to help facilitate manually pushing the fitting 1800 into connection with a pipe.

The saddle 1802 includes first and second arms 1820, 1822, which operate to support the fitting 1800 on a pipe, for example, when inserting a tap of the tap member 1874 into the pipe. The arms 1820 and 1822 include corresponding jaw and catch portions, for wrapping around the pipe to couple the saddle 1802 to the pipe and inhibiting movement of the saddle 1802 away from the pipe when the saddle 1802 is coupled to the pipe. As should be apparent, any suitable configuration of the arms 1820, 1822 (including those described herein) may be used to couple the saddle 1802 to the pipe.

Similar to embodiments described above, tap member 1874 includes two support arms 1878 (broadly, at least one support arm as, in various embodiments, tap members may include a single support arm, three support arms, four support arms, etc.). The support arms 1878 are configured to couple the tap member 1874 to the saddle 1802 and to allow the tap member 1874 to move relative to the saddle 1802 (e.g., between a first and second position as described for fitting 1300, 1400, etc.). As shown in FIG. 52, the saddle 1802 includes two lock portions 1881 (broadly, at least one lock portion 1881). The lock portions 1881 are adapted to contact corresponding ends of the support arms 1878 when the tap member 1874 is rotated to a lock position. For example, FIGS. 52 and 53 illustrate the tap member 1874 in a lock position where the lock portions 1881 are contacting ends of the support arms 1874 to inhibit vertical movement of the tap member 1874 relative to the saddle 1802 (as viewed in FIG. 52) (e.g., to inhibit a user from moving the tap member 1874 downward towards the saddle 1802, etc.). Positioning the tap member 1874 in the lock position may facilitate installation of the fitting 1800 to a pipe (as the saddle 1802 may be coupled to the pipe by pushing on the tap member 1874, which is held in place relative to the saddle 1802 by the lock portions 1881).

As shown in FIG. 52, each of the lock portions 1881 are disposed on the saddle 1802 adjacent a slot 1880 through which the support arms 1878 extend (such that the saddle 1802 broadly includes at least one slot 1880). The lock portions 1881 may include any suitable tabs, protrusions, pockets, etc. capable of contacting the support arms 1878 to inhibit the support arms 1878 from moving through the slots 1880. Therefore, when the tap member 1874 is in the lock position, again, a user may press on a top of the tap member 1874 (e.g., exert downward pressure on a top surface of the tap member 1874, etc.) to facilitate coupling the saddle 1802 to a pipe. For example, a user may desire to couple the arms 1820, 1822 of the saddle 1802 about the pipe prior to piercing the pipe with tap member 1874. The lock position allows the user to press on the tap member 1874 to exert force and push the arms 1820, 1822 of the saddle 1802 around the sides of the pipe to couple the saddle 1802 to the pipe, without simultaneously piercing the pipe with the tap member 1874 (and without inadvertently flattening the pipe with the tap of the tap member 1874, which may then make positioning the arms 1820, 1822 around the pipe more difficult).

Once the saddle 1802 is coupled to the pipe (e.g., with arms 1820, 1822 extending about at least a portion of the pipe, etc.) the user may rotate the tap member 1874 to an unlock position. FIG. 53 illustrates a rotation direction 1883, which allows the tab member 1874 to move between the lock position and the unlock position. For example, slots 1880 each have a width sufficient to allow the support arms 1878 to move laterally in the slots 1880 from the lock position (e.g., where an ends of the support arms 1878 contact the lock portions 1881, etc.) to an unlock position (e.g., where the ends of support arms 1878 do not contact the lock portions 1881, etc.). Once the support arms 1878 are moved to the unlock position, the ends of the support arms 1878 are allowed to clear the lock potions 1881 (and move by the lock portions 1881), and the tap member 1874 can be moved downwards towards the saddle 1802 (e.g., to push the tap of the tab member 1874 into a pipe, as generally described above in connection with the fittings 1300, 1400, etc.). In some embodiments, the lock portions 1881 may only contact a portion of the ends of the support arms 1878 so that the tap member 1874 can be rotated less than a width of the support arms 1878 to move from the lock position to the unlock position. As should be apparent, other embodiments may include more or less rotation to move the tap member 1874 from the lock position to the unlock position.

Once the tap member 1878 has been moved to the unlock position, a user may move the tap member 1878 relative to the saddle 1802 by pressing downwards on the tap member 1878 (e.g., by exerting a downward pressure on a top surface of the tap member 1874, etc.). This allows the tap member 1878 to move towards the saddle 1802 (and relative to the saddle) to pierce a pipe when the saddle is coupled to the pipe.

Therefore, the lock portions 1881 allow a user to rotate the tap member 1874 to the lock position so that the user can press downwards on the tap member 1874 to facilitate coupling the saddle 1802 to the pipe (e.g., without also simultaneously piercing the pipe with tap member 1874, etc.). After the saddle 1802 is coupled to the pipe, the user can rotate the tap member 1874 to the unlock position (e.g., by rotating the support arm(s) 1878 in the slot(s) 1880 to clear the lock portion(s) 1881, etc.). In the unlock position, the user can then press downwards on the tap member 1874 to pierce the pipe (and facilitate establishing fluid communication between the fitting 1800 and the pipe).

As can be seen, some fittings of the present disclosure provide one piece fittings (e.g., one piece, one step, self-tapping spike press fittings; etc.) that can be coupled to and penetrated at least partly into pipes by a single step of hand pushing (and without requiring rotation of the taps, as in conventional fittings) (be it one piece fittings that are of a solid construction, or one piece fittings in which tap members are moveably coupled to saddles). The simple one step of pressing installation allows the taps to pierce the pipes without crushing the pipes. And in some aspects, the fittings are configured to have improved structures to allow enough water flow from the pipes to the lateral lines to help ensure that sufficient fluid flows through the fittings for operating component coupled thereto (e.g., at least about 4 gallons per minute, at least about 4.5 gallons per minute, at least about 5 gallons per minute, etc.).

As can also be seen, the cross supports of the taps (and their solid vertex portions), in the fittings herein having such cross supports, helps add strength to the tips of the taps as they pierce pipes. Spikes/taps in conventional fittings are completely hollow to maximize water flow. The fittings of the present disclosure are able to maximize water flow through the taps by having thinner walls, thereby not increasing the diameters of the taps and making it possible to push the taps into the pipes (instead of having to rotate the taps or thread the taps in order to pierce the pipes). Because the walls of the taps, in the present disclosure, are generally thinner, the solid construction of the vertex portions of the taps (and the cross support design, configuration, etc.) provides additional strength to the tap.

Further, in the fittings of the present disclosure, pushing the taps of the fittings into the pipes may create better seals between the fittings and the pipes, than between conventional fittings requiring rotation to be inserted into pipes. In conventional fittings, when rotating the fittings to pierce the pipes, the rotating operation may damage the pipe along the pierced edges of the pipe (e.g., due to friction, abrasion, etc.). As such, seals between the pipe and the fittings may be compromised and the pipes may leak at the points of connection. In contrast, by pushing the taps of the fittings directly into the pipes, as with the fittings of the present disclosure, potential damage resulting from friction or abrasion associated with conventional rotation may be inhibited.

It should be appreciated that quick-connect openings and quick-connect protrusions, as used herein, may be interchanged between fittings and connectors of assemblies in various embodiments. For example, fittings may have quick-connect openings and/or quick-connect protrusions, and connectors may have quick-connect openings and/or quick-connect protrusions (in configurations described herein, or otherwise).

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fitting for use in making a fluid connection with a pipe, the fitting comprising:
a saddle adapted to couple the fitting to the pipe, the saddle including a body and first and second arms configured to extend at least partly around the pipe when coupling the fitting to the pipe; and
a tap member adapted to insert at least partly into the pipe when the saddle couples the fitting to the pipe, to thereby establish the fluid connection between the fitting and the pipe, the tap member including at least one support arm configured to moveably couple the tap member to the saddle such that the first and second arms of the saddle can be extended at least partly around the pipe prior to inserting the tap member at least partly into the pipe.

2. The fitting of claim 1, wherein the saddle defines at least one slot, the at least one support arm of the tap member configured to extend through the at least one slot to thereby moveably couple the tap member to the saddle.

3. The fitting of claim 2, wherein the at least one slot of the saddle includes two slots and wherein the at least one support arm of the tap member includes two support arms.

4. The fitting of claim 3, wherein each support arm of the tap member includes a ledge at an end portion of the support arm to inhibit removal of the support arm from the corresponding slot of the saddle and to thereby maintain coupling of the tap member to the saddle.

5. The fitting of claim 2, wherein the saddle includes a lock portion adjacent the at least one slot, and the at least one support arm of the tap member is configured to rotate between a lock position where the at least one support arm contacts the lock portion of the saddle to inhibit movement of the tap member relative to the saddle for facilitating coupling the saddle to the pipe via downward pressure exerted on the tap member, and a coupling position where the at least one support arm does not contact the lock portion, thereby allowing the tap member to move relative to the saddle for facilitating inserting the tap member at least partly into the pipe.

6. The fitting of claim 1, wherein the tap is configured to press-fit into the pipe, without threading the tap relative to the saddle, for establishing the fluid connection between the fitting and the pipe.

7. The fitting of claim 1, wherein the tap member includes a tap configured to pierce the pipe; and
wherein the saddle further defines a central opening for receiving the tap when the tap member is inserted at least partly into the pipe.

8. The fitting of claim 7, wherein the tap includes at last one tab located along the tap and configured to inhibit movement of the tap out of the pipe after the tap pierces the pipe.

9. The fitting of claim 8, wherein the tab is configured to extend past a pierced portion of the pipe after the tap pierces the pipe.

10. The fitting of claim 7, wherein the tap member includes at least one clasp adapted to couple the tap member to the saddle to inhibit movement of the tap out of the pipe after the tap pierces the pipe.

11. The fitting of claim 10, wherein the at least one clasp extends from a portion of the at least one support arm.

12. A snap clip for coupling a connector to a fitting in an irrigation system, the snap clip comprising:
a first wall portion having an outer threaded surface and an inner non-threaded surface;
a second wall portion opposite the first wall portion, the second wall portion having an outer threaded surface and an inner non-threaded surface; and
a bridge member coupling the first wall portion to the second wall portion, the bridge member separating the outer threaded surface of the first wall portion form the outer threaded surface of the second wall portion.

13. The snap clip of claim 12, wherein the bridge member, the first wall portion and the second wall portion define an arc; and
wherein the bridge member is flexible to allow compression of the bridge member such that the first wall portion and the second wall portion may be pressed towards one another, whereby the snap clip may be inserted into a threaded opening of the fitting and then expanded outwards into the threaded opening of the fitting to couple the snap clip to the threaded opening.

14. The snap clip of claim 13, wherein the first wall portion and the second wall portion each include a stop surface lip extending away from the respective wall portion at an upper end of the snap clip, thereby providing a stop surface for contacting an end portion of the threaded opening of the fitting to facilitate a predetermined depth of the snap clip extending into the threaded opening of the fitting.

15. The snap clip of claim 12, wherein the first wall portion, the second wall portion and the bridge member are integral, and each wall portion includes at least three external male threads

16. The snap clip of claim 12, wherein the snap clip is integrally formed at an end of one of an irrigation fitting and an irrigation connector.

17. A method of using a snap clip to couple a connector to a fitting for use in making a fluid connection with a pipe, the snap clip including at least one wall portion having an external threaded surface and an internal non-threaded surface, the method comprising:
installing the snap clip to one of a threaded opening of the fitting or a protrusion of the connector to create a threaded coupling of the snap clip to the opening of the fitting or the protrusion of the connector; and
after such installation, inserting the protrusion of the connector into the opening of the fitting to create a friction fit, via the snap clip, between the protrusion of the connector and the opening of the fitting.

18. The method of claim 17, wherein installing the snap clip includes inserting the snap clip into the threaded opening of the fitting; and
wherein inserting the snap clip into the threaded opening of the fitting includes:
compressing the snap clip such that an outer diameter of the external threaded surface of the snap clip is less than an inner diameter of the threaded opening of the fitting to facilitate insertion of the snap clip into the opening of the fitting without rotation of the snap clip; and
releasing the snap clip such that the external threaded surface expands to contact the threaded opening of the fitting to create the threaded coupling of the snap clip to the opening of the fitting.

19. The method of claim 18, wherein the snap clip includes a stop surface lip at one end of the snap clip; and
wherein inserting the snap clip includes inserting the snap clip into the opening of the fitting until the stop surface lip contacts an end of the opening of the fitting, thereby facilitating insertion of the snap clip into the opening of the fitting at a fixed depth.

20. The method of claim 17, wherein the protrusion of the connector defines a ledge, and wherein installing he snap clip includes inserting the protrusion of the connector into the snap clip and moving the ledge past the snap clip so the ledge inhibits removal of the snap clip from the protrusion of the connector.
